(19) United States
(12) Patent Application Publication
(10) Pub. No.: US 2012/0041575 A1
(43) Pub. Date: Feb. 16, 2012

(54) Anomaly Detection Method and Anomaly Detection System

(75) Inventors: Shunji Maeda, Yokohama (JP); Hisae Shibuya, Chigasaki (JP)

(73) Assignee: Hitachi, Ltd., Chiyoda-ku, Tokyo (JP)

(21) Appl. No.: 13/144,343

(22) PCT Filed: Oct. 29, 2009
(86) PCT No.: PCT/JP2009/068566

§ 371 Date: Jul. 13, 2011

(30) Foreign Application Priority Data
Feb. 17, 2009 (JP) 2009-033380

(51) Int. Cl. G05B 9/02; G06F 15/18

(52) U.S. Cl. 700/80; 700/79

(57) ABSTRACT

(1) A compact set of learning data about normal cases is created using the similarities among data as key factors, (2) new data is added to the learning data according to the similarities and occurrence/nonoccurrence of an anomaly, (3) the alarm occurrence section of a facility is deleted from the learning data, (4) a model of the learning data updated at appropriate times made by the subspace method, and an anomaly candidate is detected on the basis of the distance between each piece of the observation data and a subspace, (5) analyses of event information are combined and an anomaly is detected from the anomaly candidates, and (6) the deviance of the observation data is determined on the basis of the distribution of histograms of use of the learning data, and the abnormal element (sensor signal) indicated by the observation data is identified.

The present application is the U.S. National Phase of International Application No. PCT/2009/068566, filed on Oct. 29, 2009, which claims the benefit of Japanese Patent Application No. 2009-033380, filed Feb. 17, 2009, the entire contents of which are hereby incorporated by reference.

### TECHNICAL FIELD

The present invention relates to an anomaly detection method and an anomaly detection system for early detection of an anomaly of a plant or a facility.

### BACKGROUND ART

A power company utilizes waste heat of a gas turbine or the like to supply heated water for district heating and to supply high-pressure steam or low-pressure steam to factories. A petrochemical company operates a gas turbine or the like as a power-supply facility. In various plants and facilities which use gas turbines or the like as described above, an early detection of an anomaly in such gas turbines enables damage to society to be minimized and is therefore extremely important.

In addition to gas turbines and steam turbines, while too numerous to comprehensively list here, facilities for which early detection of an anomaly is vital nevertheless include a water wheel at a hydroelectric power plant, a nuclear reactor of a nuclear power plant, a windmill of a wind power plant, an engine of a aircraft or heavy machinery, a railroad vehicle or track, an escalator, and an elevator, as well as degradation/operating life of a mounted battery if a device/parts level is to be considered. Recently, detection of anomalies (various symptoms) with respect to the human body is becoming important as seen in electroencephalographic measurement/diagnosis for the purpose of health administration.

To this end, for example, Smart Signal Corporation, U.S.A., provides anomaly detection services primarily for engines as described in Patent Literature 1 and Patent Literature 2. At Smart Signal Corporation, previous data is retained as a database (DB), a similarity between observation data and previous learning data is calculated by a proprietary method, an estimated value is calculated by a linear combination of data with high similarities, and an outlyingness between the estimated value and the observation data is outputted. Meanwhile, Patent Literature 3 shows that there are examples in which anomaly detection is performed by k-means clustering as is the case of General Electric Company.

### CITATION LIST

### Patent Literature

Patent Literature 1: U.S. Pat. No. 6,952,662
Patent Literature 2: U.S. Pat. No. 6,975,962
Patent Literature 3: U.S. Pat. No. 6,216,066

### Non-Patent Literature

Non-Patent Literature 1: Stephan W. Wegerich; Nonparametric modeling of vibration signal features for equipment health monitoring, Aerospace Conference, 2003. Proceedings. 2003 IEEE, Volume 7, Issue, 2003 Page(s): 3113-3121

### SUMMARY OF INVENTION

### Technical Problem

With the method employed by Smart Signal Corporation, previous learning data to be stored in the database must exhaustively contain various states. If observation data not included in the learning data is observed, all such observation data is to be handled as data not included in learning data and is determined to be outliers. As a result, even a normal signal is to be determined as being anomalous and a significant degradation in inspection reliability occurs. Therefore, it is essential that a user store all data of all previous states in the form of a DB.

On the other hand, when an anomaly is present in learning data, a deviance from observation data representing an anomaly becomes smaller and may result in the anomaly being overlooked. Therefore, the learning data must be sufficiently checked for the presence of anomalies.

As shown, with the method proposed by Smart Signal Corporation, a user is burdened by exhaustive data collection and anomaly elimination. In particular, detailed responses are required with respect to variation with time, fluctuations in the surrounding environment, performance or nonperformance of maintenance work such as part replacement, and the like. Undertaking such responses manually is substantially difficult and, in some cases, impossible.

Since the method of General Electric Company is based on k-means clustering, signal behavior is not observed. In this respect, essentially, anomaly detection is not achieved.

In consideration thereof, an object of the present invention is to solve the problems described above and to offer a method of generating quality learning data and, accordingly, to provide an anomaly detection method and system capable of reducing user load and detecting anomalies early at high sensitivity.

### Solution to Problem

In order to achieve the object described above, the present invention is configured such that (1) a compact set of learning data including normal cases is generated by focusing on similarities among data, (2) new data is added to the learning data according to the similarities and occurrence/nonoccurrence of an anomaly, (3) an alarm occurrence section of a facility is deleted from the learning data, (4) a model of the learning data updated at appropriate times is made by the subspace method, and anomaly candidates are detected on the basis of a distance relationship between each piece of the observation data and a subspace, (5) analyses of event information are combined and an anomaly is detected from the anomaly candidates, and (6) a deviance of the observation data is determined on the basis of a histogram of use of the learning data, and an anomalous element (sensor signal) indicated by the observation data is identified.

In addition, for a plurality of pieces of observation data, a similarity between individual pieces of data included in the learning data and the observation data is obtained and k pieces of data (where k denotes a parameter) with highest similarities to the observation data are obtained, a histogram of data included in the obtained learning data is obtained and, based on the histogram, at least one or more values such as a typical value, an upper limit, and a lower limit is set, and an anomaly is monitored on a daily basis using the set values.

### Advantageous Effects of the Invention

According to the present invention, quality learning data can be obtained and, in addition to facilities such as gas turbines and steam turbines, an anomaly can be detected early and at high accuracy with respect to various facilities and parts including a water wheel at a hydroelectric power plant, a nuclear reactor of a nuclear power plant, a windmill of a wind power plant, an engine of a aircraft or heavy machinery, a railroad vehicle or track, an escalator, and an elevator, as well as degradation/operating life of a mounted battery if a device/parts level is to be considered.

### BRIEF DESCRIPTION OF DRAWINGS

FIG. 1 is an example of an anomaly detection system according to the present invention which uses learning data including normal cases and integrates a plurality of classifiers.

FIG. 2 is an example of linear feature transformation.

FIG. 3 is a configuration example of an evaluation tool.

FIG. 4 is a diagram describing a relationship with anomaly diagnosis.

FIG. 5 is a hardware configuration diagram of an anomaly detection system according to the present invention.

FIG. 6 is an example of a classification configuration according to integration of a plurality of classifiers.

FIG. 7 is an operational flow diagram of editing learning data of an anomaly detection system according to a first embodiment of the present invention.

FIG. 8 is a configuration block diagram of editing learning data of the anomaly detection system according to the first embodiment of the present invention.

FIG. 9 is an operational flow diagram of editing learning data of an anomaly detection system according to a second embodiment of the present invention.

FIG. 10 is a configuration block diagram of editing learning data of the anomaly detection system according to the second embodiment of the present invention.

FIG. 11 is an operational flow diagram of editing learning data of an anomaly detection system according to a third embodiment of the present invention.

FIG. 12 is a configuration block diagram of editing learning data of the anomaly detection system according to the third embodiment of the present invention.

FIG. 13 is an explanatory diagram of representative levels of a sensor signal according to the third embodiment of the present invention.

FIG. 14 is an example of a histogram of levels of a sensor signal according to the third embodiment of the present invention.

FIG. 15 is an example of event information (alarm information) generated by a facility in an anomaly detection system according to a fourth embodiment of the present invention.

FIG. 16 is an example of data represented in a feature space in an anomaly detection system according to a fifth embodiment of the present invention.

FIG. 17 is another example of data represented in a feature space.

FIG. 18 is a configuration diagram illustrating an anomaly detection system according to a sixth embodiment of the present invention.

FIG. 19 is an example of multidimensional time-series signals.

FIG. 20 is an example of a correlation matrix.

FIG. 21 is an application example of trajectory segmentation clustering.

FIG. 22 is an application example of trajectory segmentation clustering.

FIG. 23 is an application example of trajectory segmentation clustering.

FIG. 24 is an example of a subspace method.

FIG. 25 is an example of anomaly detection by integration of a plurality of classifiers.

FIG. 26 is an example of a deviation from a model during implementation of trajectory segmentation clustering.

FIG. 27 is an example of a deviation from a model when trajectory segmentation clustering is not implemented.

FIG. 28 is an application example of a local subspace classifier.

FIG. 29 is an application example of a projection distance method and a local subspace classifier.

FIG. 30 is yet another example of data represented in a feature space.

FIG. 31 is still another example of data represented in a feature space.

FIG. 32 is a configuration diagram illustrating an anomaly detection system according to a seventh embodiment of the present invention.

FIG. 33 is a configuration diagram illustrating an anomaly detection system according to an eighth embodiment of the present invention.

FIG. 34 is an example of a histogram of an alarm signal.

FIG. 35 is a configuration diagram illustrating an anomaly detection system according to a ninth embodiment of the present invention.

FIG. 36 is an example of wavelet (transform) analysis.

FIG. 37 is an explanatory diagram of wavelet transform.

FIG. 38 is a configuration diagram illustrating an anomaly detection system according to a tenth embodiment of the present invention.

FIG. 39 is an example of scatter diagram analysis and cross-correlation analysis.

FIG. 40 is a configuration diagram illustrating an anomaly detection system according to an eleventh embodiment of the present invention.

FIG. 41 is an example of time/frequency analysis.

FIG. 42 is a configuration diagram illustrating an anomaly detection system according to a twelfth embodiment of the present invention.

FIG. 43 is a configuration diagram illustrating details of the anomaly detection system according to the twelfth embodiment of the present invention.

### DESCRIPTION OF EMBODIMENTS

Hereinafter, embodiments of the present invention will be described with reference to the drawings.

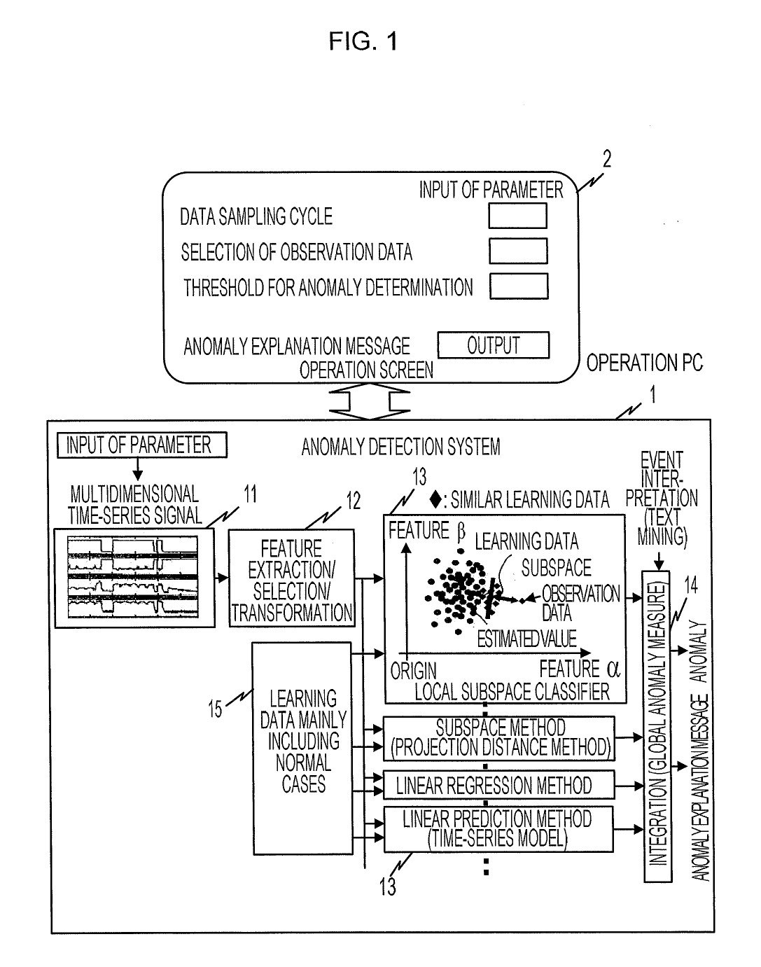

FIG. 1 is a diagram illustrating an example of a system configuration including an anomaly detection system according to the present invention which uses learning data including normal cases and integrates a plurality of classifiers.

The anomaly detection system (1) generates a compact set of learning data including normal cases by focusing on similarities among data, (2) adds new data to the learning data according to the similarities and occurrence/nonoccurrence of an anomaly, (3) deletes an alarm occurrence section of a facility from the learning data, (4) makes a model of the learning data updated at appropriate times by the subspace method, and detects anomaly candidates on the basis of a distance relationship between each piece of the observation data and a subspace, (5) combines analyses of event information and detects an anomaly from the anomaly candidates, and (6) determines a deviance of the observation data on the basis of a histogram of use of the learning data, and identifies an anomalous element (sensor signal) indicated by the observation data.

In addition, for a plurality of pieces of observation data, a similarity between individual pieces of data included in the learning data and the observation data is obtained and k pieces of data with highest similarities to the observation data are obtained, a histogram of data included in the obtained learning data is obtained and, based on the histogram, at least one or more values such as a typical value, an upper limit, and a lower limit is set, and an anomaly is monitored using the set values.

In an anomaly detection system 1 illustrated in FIG. 1, 11 denotes a multidimensional time-series signal acquiring unit, 12 denotes a feature extracting/selecting/transforming unit, 13, 13, . . . denote classifiers, 14 denotes integration (global anomaly measure), and 15 denotes learning data mainly including normal cases. A multidimensional time-series signal inputted from the multidimensional time-series signal acquiring unit 11 is subjected to: dimension reduction at the feature

extracting/selecting/transforming unit 12; classification by the plurality of classifiers 13, 13, . . . ; and determination of global anomaly measure by the integration (global anomaly measure) 14. The learning data mainly including normal cases 15 is also classified by the plurality of classifiers 13, 13, . . . and used to determine a global anomaly measure. At the same time, the learning data mainly including normal cases 15 itself is also sorted out and accumulated/updated in order to improve accuracy.

FIG. 1 also illustrates an operation PC 2 that is used by a user to input parameters. Parameters inputted by the user include a data sampling cycle, selection of observation data, a threshold for anomaly determination, and the like. For example, a data sampling cycle instructs data to be acquired every specified number of seconds. A selection of observation data instructs which sensor signal is to be mainly used. A threshold for anomaly determination is a threshold for binarizing a calculated value of anomalousness that is also expressed as a deviation/deviancy from a model, an outlier, a deviance, an anomaly measure, and the like.

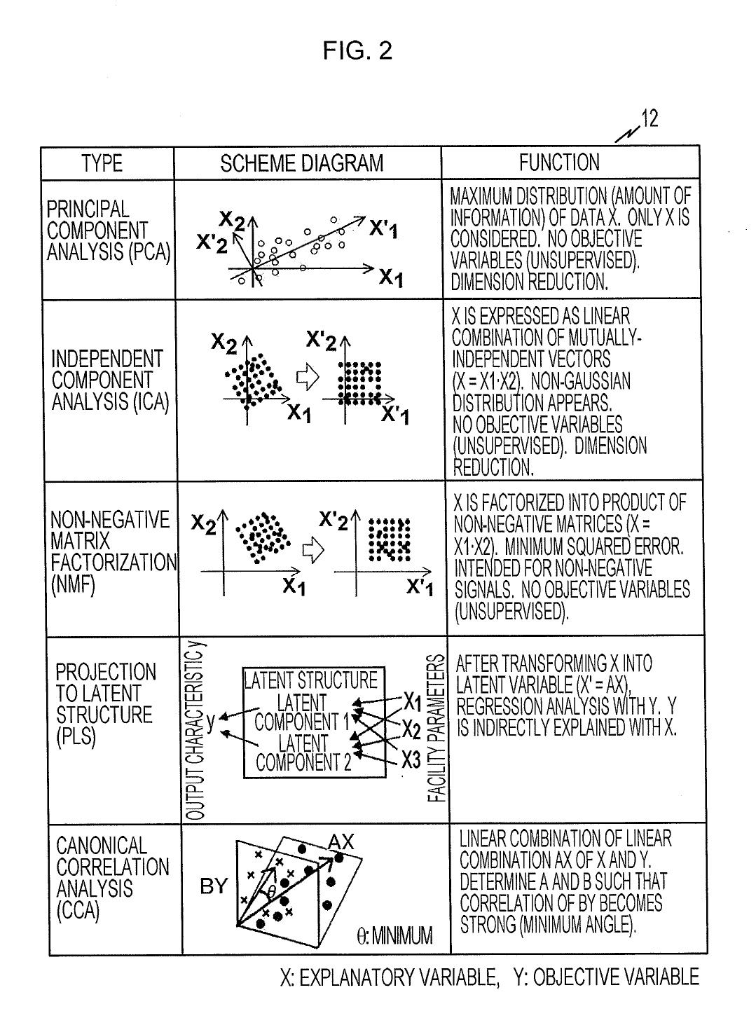

FIG. 2 illustrates an example of a feature transformation 12 that reduces a dimension of the multidimensional time-series signal used in FIG. 1. There are several applicable methods other than principal component analysis such as independent component analysis, non-negative matrix factorization, projection to latent structure, and canonical correlation analysis. FIG. 2 illustrates scheme diagrams and functions in conjunction with each other. Principal component analysis is also referred to as PCA and is a method mainly used for dimension reduction. Independent component analysis is also referred to as ICA and is effective as a method for exposing non-Gaussian distributions. Non-negative matrix factorization is also referred to as NMF and factorizes a sensor signal given as a matrix into non-negative components. “Unsupervised” denotes transformation methods that are effective when the number of anomalous cases is small and cannot be utilized as in the present embodiment. In this case, an example of linear transformation is shown. Non-linear transformation is also applicable.

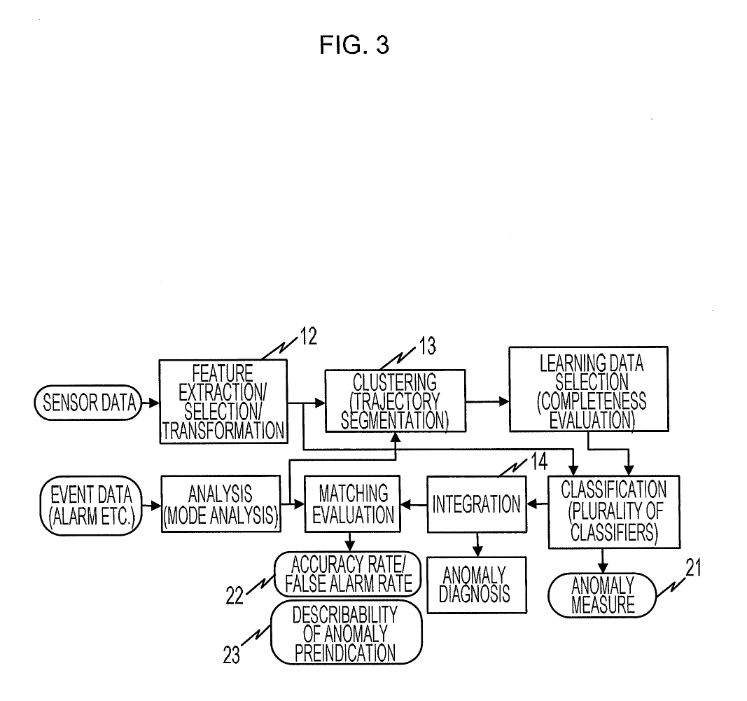

FIG. 3 presents a summary of evaluation systems of methods that perform learning data selection (completeness evaluation) and anomaly diagnosis using sensor data and event data (alarm information or the like). An anomaly measure 21 according to classification by a plurality of classifiers and an accuracy rate/false alarm rate 23 according to matching evaluation are evaluated. In addition, a describability of anomaly preindication 22 is also subject to evaluation.

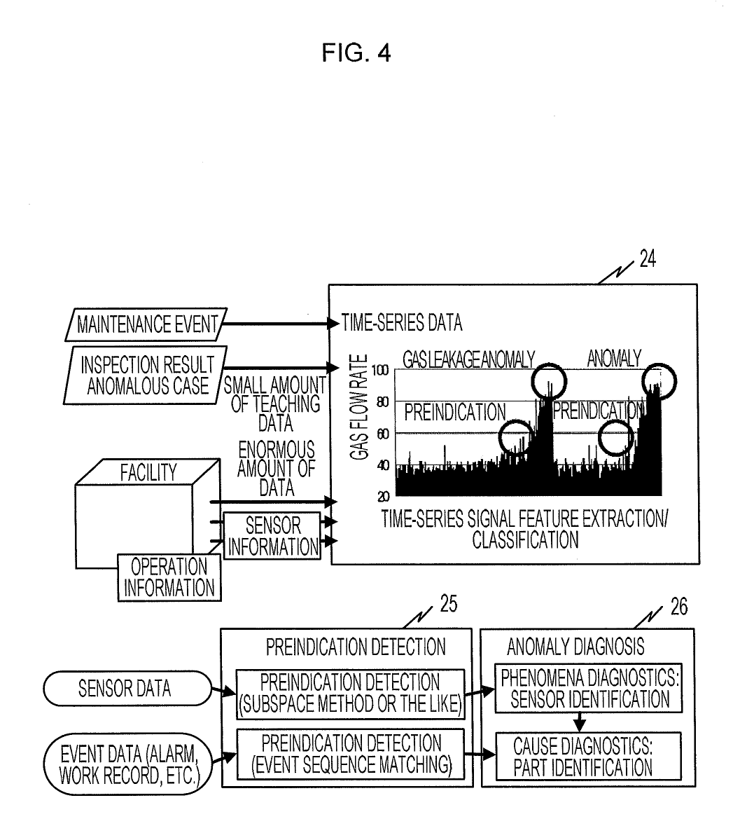

FIG. 4 illustrates anomaly detection and diagnoses after anomaly detection. In FIG. 4, an anomaly is detected from a time-series signal from a facility by time-series signal feature extraction/classification 24. The number of facilities is not necessarily limited to one. A plurality of facilities may be considered as objects. At the same time, collateral information such as information regarding a maintenance event (an alarm or a work record: specifically, activation, shutdown, and operation condition settings of a facility, information on various failures, information on various warnings, routine inspection information, operation environment such as installation temperature, accumulated operation time, part replacement information, adjustment information, cleaning information, and the like) of each facility is retrieved to detect an anomaly at high sensitivity.

As illustrated in the drawings, if a discovery can be made early as a preindication by preindication detection 25, measures of some kind or another can be taken before a failure occurs and operation must be shut down. Subsequently, on the basis of a preindication detected by preindication detection such as a subspace method or by event sequence matching, an anomaly diagnosis is performed to identify a part that is a failure candidate or to estimate when the part is expected to fail or shut down. Accordingly, arrangement for necessary parts is performed at necessary timings.

Anomaly diagnosis 26 is easily conceivable when divided into phenomena diagnostics in which a sensor containing a preindication is identified and cause diagnostics in which a part that may potentially cause a failure is identified. An anomaly detecting unit outputs information regarding a feature amount in addition to a signal referred to as an occurrence/nonoccurrence of an anomaly to an anomaly diagnosis unit. The anomaly diagnosis unit carries out a diagnosis on the basis of such information.

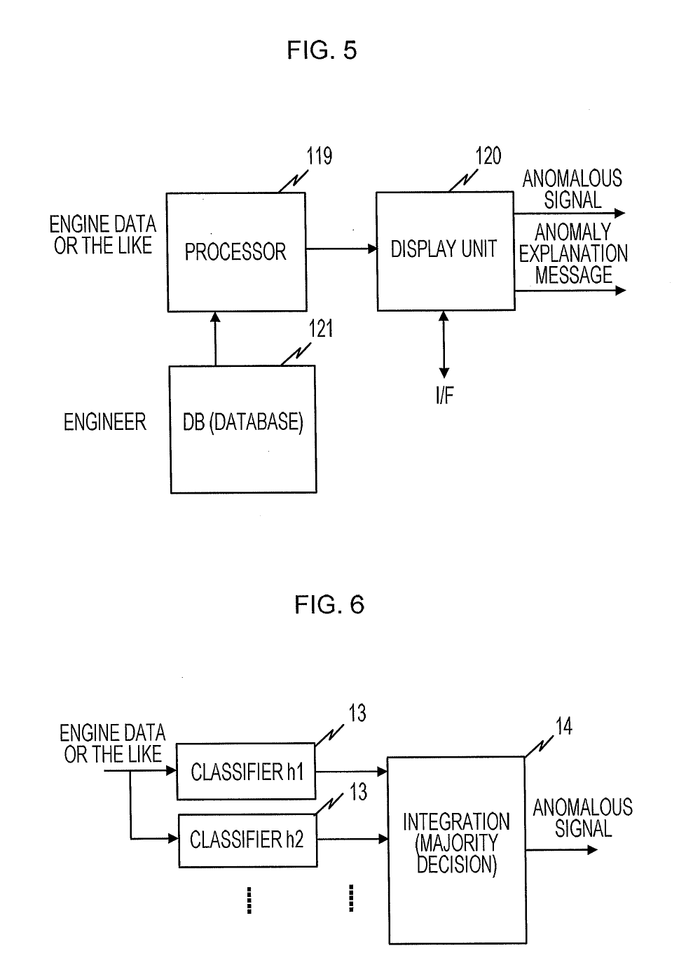

FIG. 5 illustrates a hardware configuration of an anomaly detection system according to the present invention. Sensor data of an object engine or the like is inputted to a processor 119 that executes anomaly detection, and after correcting missing values and the like, the sensor data is stored in a database DB 121. The processor 119 uses DB data made up of acquired observation sensor data and learning data to perform anomaly detection. A display unit 120 performs various displaying and outputs a presence/absence of an anomalous signal and an anomaly explanation message to be described later. Trends can also be displayed. A result of event interpretation, to be described later, can also be displayed.

The database DB 121 can be operated by a skilled engineer or the like. In particular, anomalous cases and countermeasure cases can be taught and stored. (1)

Learning data (normal), (2) anomalous data, and (3) countermeasure contents are to be stored. By adopting a structure in which the database DB can be reconfigured by a skilled engineer or the like, a sophisticated and useful database may be completed. In addition, data manipulation is to be performed by automatically relocating learning data (individual pieces of data, position of a center of gravity, or the like) in accordance with an occurrence of an alarm or replacement of a part. Furthermore, acquired data can also be added automatically. If anomalous data exists, a method such as generalized vector quantization can also be applied to data relocation.

For the plurality of classifiers 13 illustrated in FIG. 1, several classifiers (h1, h2, . . . ) can be prepared to make a majority decision (integration 14). In other words, ensemble (group) learning using different classifier groups (h1, h2, . . . ) can be applied. A configuration example thereof is illustrated in FIG. 6. For example, a first classifier may be a projection distance method, a second classifier may be a local subspace classifier, and a third classifier may be a linear regression method. Any classifier can be applied as long as case data is used as a basis.

### First Embodiment

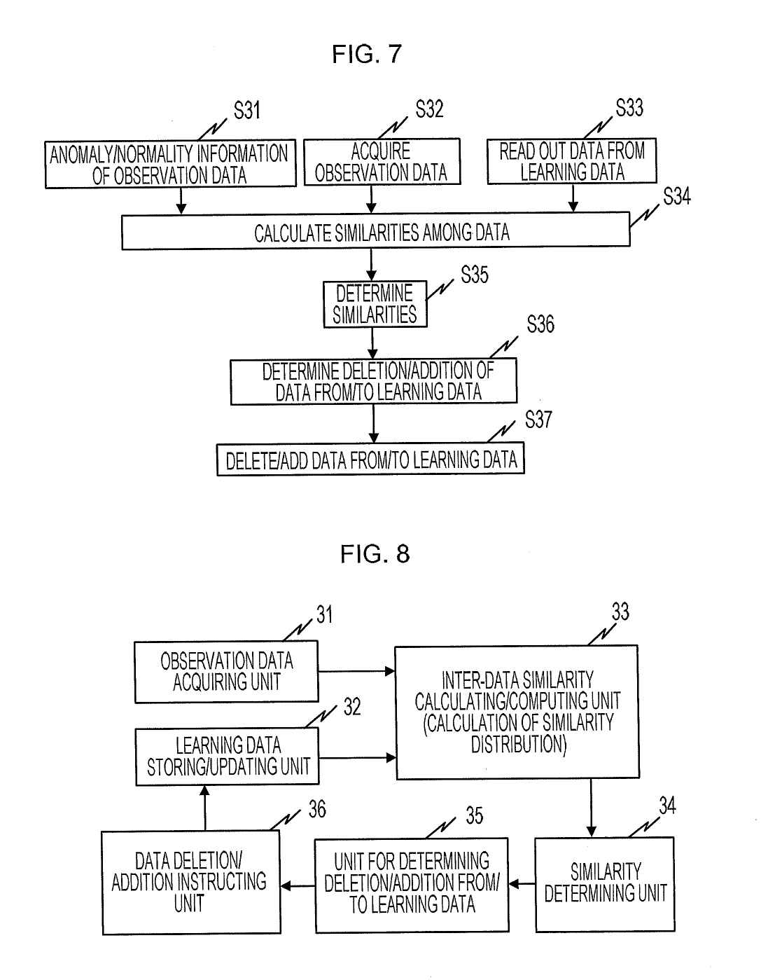

First, accumulation, update, and improvement of learning data mainly storing normal cases which is a first embodiment of an anomaly detection system according to the present invention will be described, with a particular emphasis on an example including a case of increasing data. FIG. 7 illustrates an operational flow of editing the accumulation and updating of learning data mainly storing normal cases according to the first embodiment of the present invention, and FIG. 8 illustrates a configuration block diagram of learning data according to the first embodiment of the present invention. Contents of both drawings are to be executed by the processor 119 illustrated in FIG. 5.

In FIG. 7, attention is focused on similarities among data between observation data and learning data. Anomaly/normality information of observation data (S31) is inputted, observation data is acquired (S32), data is read out from learning data (S33), similarities among data are calculated (S34), similarities are determined (S35), deletion/addition of data from/to the learning data is determined (S36), and addition/deletion of data to/from the learning data is performed (S37). In other words, when similarity is low, there are two conceivable cases: the data is normal but is not included in existing learning data; and the data is anomalous. In the former case, an addition is made to the learning data. In the latter case, the observation data is not added to the learning data. When similarity is high, if the data is normal, the data is conceivably included in the learning data and the observation data is not added to the learning data, and if the data is anomalous, data selected from the learning data is also conceivably anomalous and is therefore deleted.

In FIG. 8, an anomaly detection system according to the first embodiment of the present invention includes an observation data acquiring unit 31, a learning data storing/updating unit 32, an inter-data similarity calculating/computing unit 33, a similarity determining unit 34, a unit for determining deletion/addition from/to learning data 35, and a data deletion/addition instructing unit 36. The inter-data similarity calculating/computing unit 33 calculates and computes a similarity between observation data from the observation data acquiring unit 31 and learning data from the learning data storing/updating unit 32, the similarity determining unit 34 determines the similarity, the unit for determining deletion/addition from/to learning data 35 determines deletion/addition from/to the learning data, and the data deletion/addition instructing unit 36 executes deletion/addition of learning data from/to the learning data storing/updating unit 32.

In this manner, using updated learning data, an anomaly of observation data is detected on the basis of a deviance between newly acquired observation data and individual pieces of data included in the learning data. A cluster may be added to learning data as an attribute. Learning data is to be generated/updated for each cluster.

### Second Embodiment

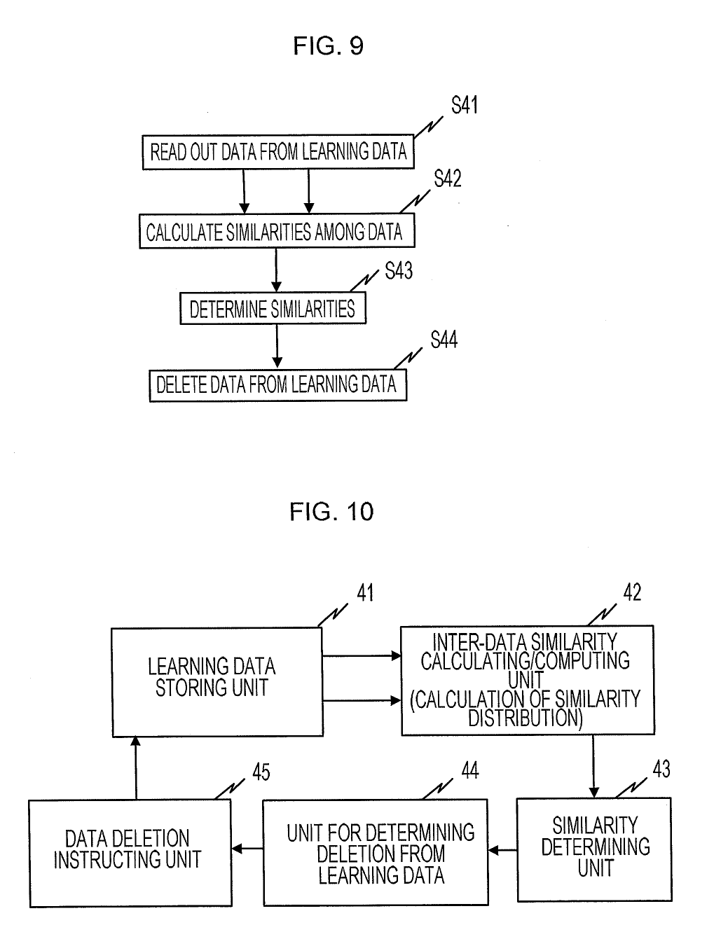

Next, a simplest example of accumulation, update, and improvement of learning data mainly storing normal cases which is a second embodiment of an anomaly detection system according to the present invention will be described. FIG. 9 illustrates an operational flow and FIG. 10 illustrates a block diagram. Contents of both drawings are to be executed by the processor 119 illustrated in FIG. 5. Duplication of learning data is reduced to obtain an appropriate amount of data. To this end, similarities among data are used.

In FIG. 9, data is read out from learning data (S41), a similarity among data is sequentially calculated for each piece of data included in the learning data (S42), and similarities are determined (S43). When similarity is high, duplication of data is considered and data is deleted from the learning data (S44) to reduce the amount of data and to minimize capacity.

When similarities are divided into several clusters or groups, a method referred to as vector quantization is adopted. A method is also conceivable in which a distribution of similarities is obtained, and when the similarities have a mixed distribution, a center of each distribution is retained. On the other hand, a method is also conceivable in which a tail of each distribution is retained. The amount of data can be reduced through such various methods. By reducing the amount of learning data, a load required to match observation data is also reduced.

In FIG. 10, an anomaly detection system according to the second embodiment of the present invention includes a learning data storing unit 41, an inter-data similarity calculating/computing unit 42, a similarity determining unit 43, a unit for determining deletion/addition from/to learning data 44, and a data deletion instructing unit 45. The inter-data similarity calculating/computing unit 42 calculates and computes a similarity among a plurality of pieces of learning data read out from the learning data storing unit 41, the similarity determining unit 43 determines the similarity, the unit for determining deletion/addition from/to learning data 44 determines deletion/addition from/to the learning data, and the data deletion instructing unit 45 executes an instruction to delete learning data in the learning data storing unit 41.

### Third Embodiment

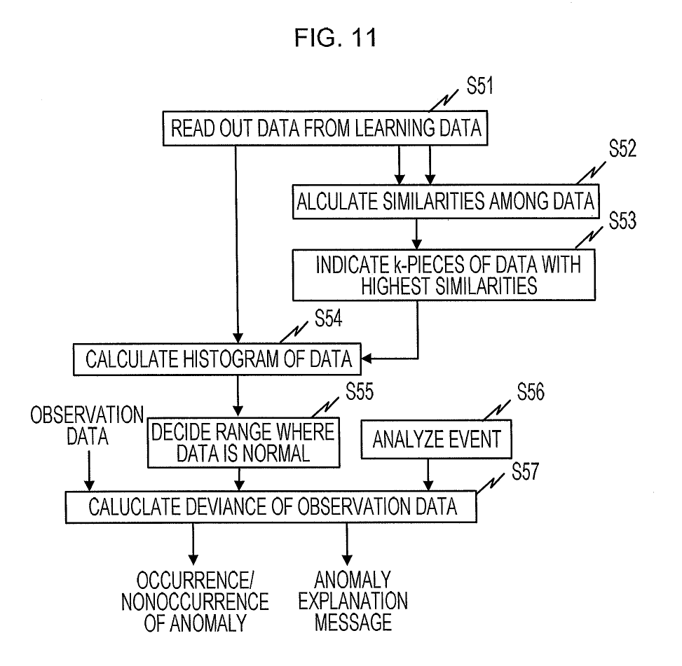

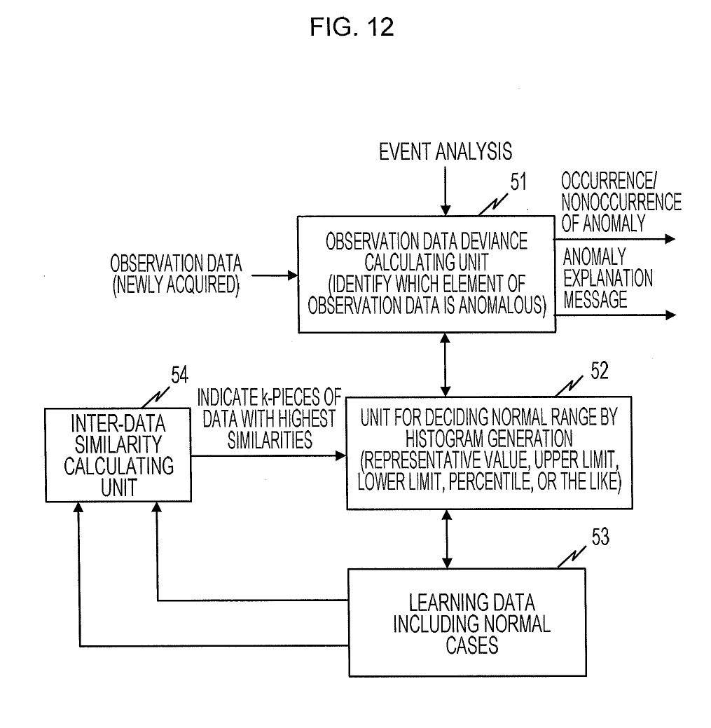

Next, another method that is a third embodiment of an anomaly detection system according to the present invention will be described with reference to FIG. 11. In a similar manner as FIGS. 7 and 9, FIG. 11 illustrates an operational flow and FIG. 12 illustrates a block diagram. Contents of both drawings are to be executed by the processor 119 illustrated in FIG. 5.

In this case, a result of event analysis, to be described later, is also matched.

As illustrated in FIG. 11, in the present embodiment, data is read out from learning data (S51), a similarity among individual pieces of data included in the learning data is calculated (S52), k pieces of data with highest similarities are obtained with respect to the individual pieces of data (S53) (similar to a method commonly referred to as a k-NN method or k-nearest neighbor method), a histogram is calculated for data included in the obtained learning data (S55), and a range of existence of normal cases is decided on the basis of the histogram (S55). In the case of the k-NN method, a similarity is a distance within a feature space. Furthermore, a result of an event analysis (S56) is also matched, a deviance of observation data is calculated (S57), and an occurrence/nonoccurrence of an anomaly and an anomaly explanation message are outputted.

In FIG. 12, an anomaly detection system according to the third embodiment of the present invention includes an observation data deviance calculating unit 51, a unit for deciding normal range by histogram generation 52, learning data including normal cases 53, and an inter-data similarity calculating unit 54. As illustrated in FIG. 12, the inter-data similarity calculating unit 54 calculates similarities among individual pieces of data included in the learning data, obtains k pieces of data with highest similarities for each individual piece of data, and instructs the k pieces of data with highest similarities to the unit for deciding normal range by histogram generation 52. The unit for deciding normal range by histogram generation 52 sets at least one or more values including a representative value, an upper limit, a lower limit, a percentile, and the like on the basis of the histogram. The observation data deviance calculating unit 51 identifies which element in the observation data is anomalous using the set values and outputs an occurrence/nonoccurrence of an anomaly. In addition, an anomaly explanation message indicating why an anomaly had been determined or the like is outputted. In this case, a different set value such as an upper limit, a lower limit, and a percentile may be set for each cluster.

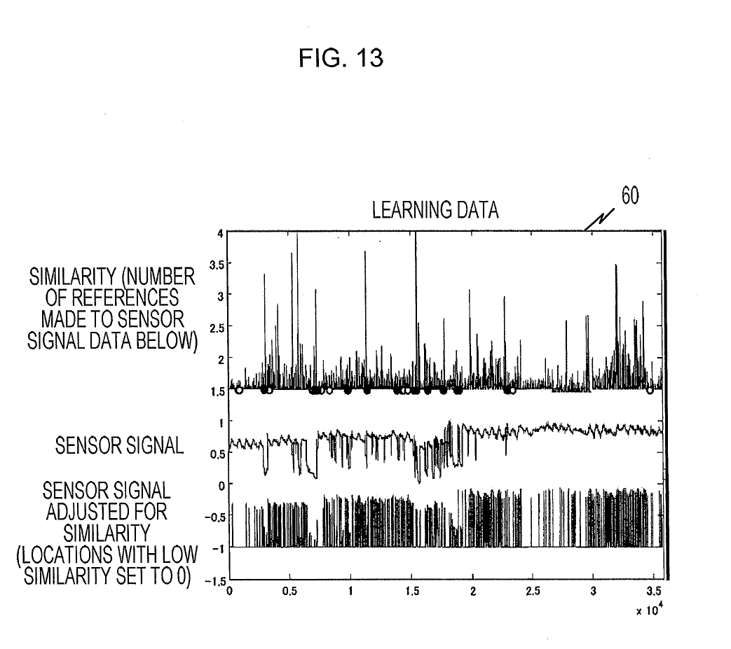

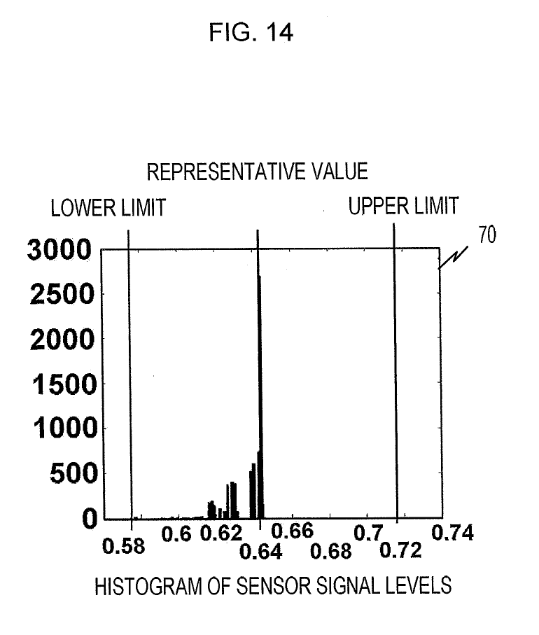

Specific examples of the anomaly detection system according to the third embodiment of the present invention are illustrated in FIGS. 13 and 14. In FIG. 13, a middle section represents time-series data of an observed sensor signal. In contrast, an upper section indicates, as frequencies, the number of times sensor signal data at other times of day has been selected as being similar to the sensor signal data. Invariably, a number k of (where k is a parameter which, in this case, is five) highest pieces of data are selected. FIG. 14 illustrates which level of the observed sensor signal has been selected on the basis of the histogram.

FIG. 14 also illustrates a representative value, an upper limit, and a lower limit. The representative values have also been indicated as a representative value, an upper limit, and a lower limit above the time-series data of the observed sensor signal illustrated in FIG. 13. This example shows that a width between the upper limit and the lower limit is small. This is due to the fact that, on the assumption of similarity, selected data is limited to the five (parameter k) highest pieces of data. In other words, the upper limit and the lower limit exist near the representative value. The width between the upper limit and the lower limit increases when the parameter k is increased. This range corresponds to a representative range of the observed sensor signal. Therefore, an occurrence/nonoccurrence of an anomaly in data is to be determined on the basis of a magnitude of outlyingness from this region.

In addition, FIG. 14 also shows that the histogram of data form several groups (categories). Accordingly, it is apparent that observed sensor signal data may selectively assume several levels. From these distribution categories, a range of existence of data can be decided in detail. While the representative value, the upper limit, and the lower limit have been plotted as constant values in FIG. 13, the values may vary over time or the like. For example, a plurality of sets of learning data may be prepared in accordance with an operating environment or operating conditions and transitions may be made accordingly.

### Fourth Embodiment

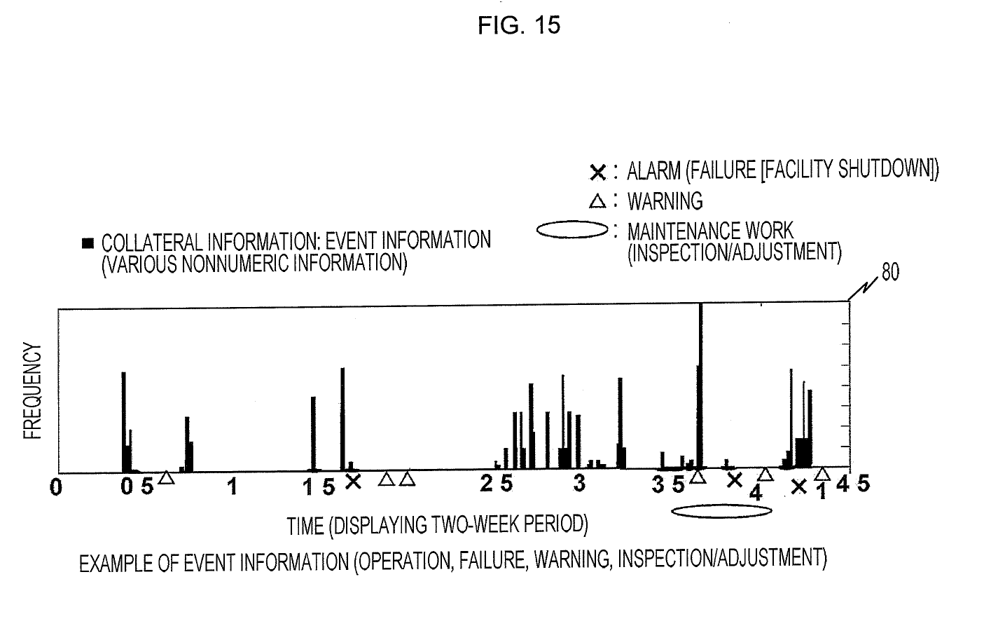

In addition, FIG. 15 illustrates event information generated by a facility in an anomaly detection system according to a fourth embodiment of the present invention. An abscissa represents time and an ordinate represents event occurrence frequency. Event information refers to an operation performed by a worker on a facility, a warning issued by a facility (which does not result in facility shutdown), a failure (which results in facility shutdown), routine maintenance, and the like. Alarm information generated by the facility regarding facility shutdown and warnings are collected.

In the anomaly detection system according to the fourth embodiment of the present invention, quality learning data is generated by removing sections including alarm information generated by the facility regarding facility shutdown and warnings from learning data. In addition, with the anomaly detection system according to the fourth embodiment of the present invention, quality learning data can be generated by removing a range including an anomaly that had occurred at the facility.

### Fifth Embodiment

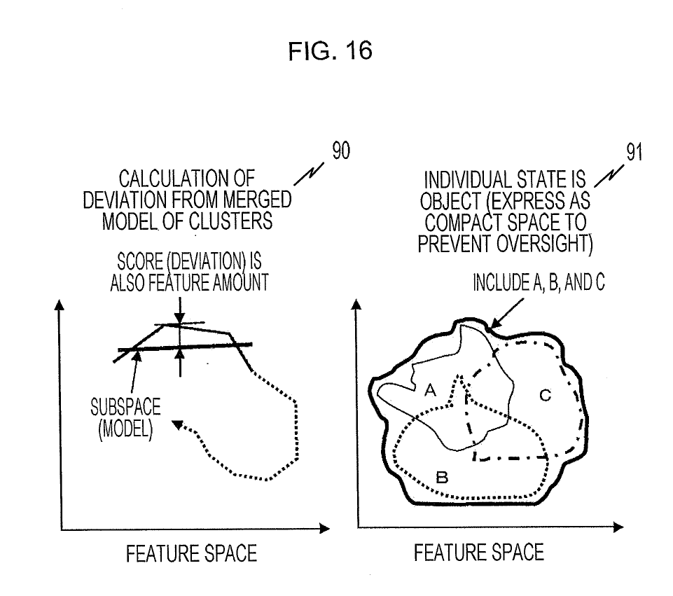

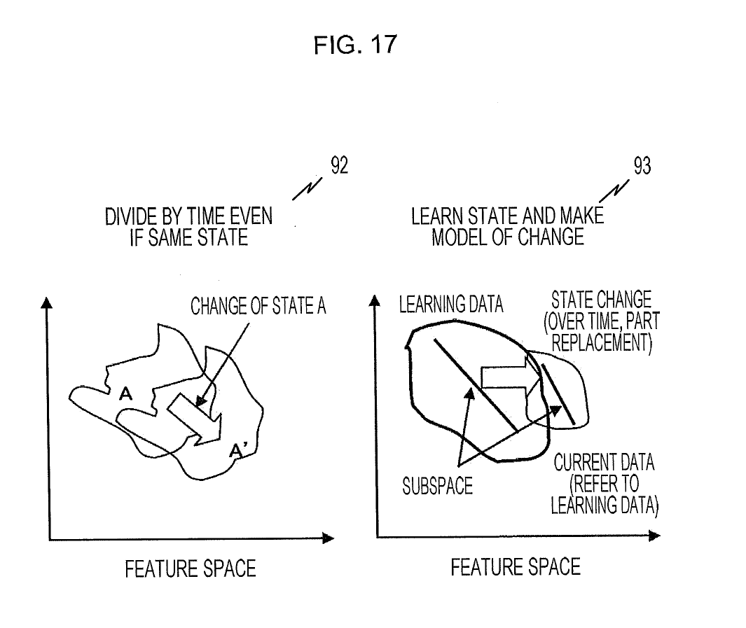

Specific examples of an anomaly detection system according to the fifth embodiment of the present invention are illustrated in FIGS. 16 and 17. Obviously, there may be cases where merely analyzing event information enables detection of an anomaly preindication. However, by combining anomaly detection performed on sensor signals with anomaly detection performed on event information, anomaly detection can be performed with higher accuracy. In addition, when calculating a similarity between observation data and learning data, event information can be used to sort out learning data to be subjected to a similarity calculation so as to narrow down learning data.

Ordinary similarity calculation is often performed on all data and therefore is referred to as a full search. However, as described in the present embodiment, object data can be limited on the basis of a cluster attribute or by classifying modes according to an operational state or an operational environment on the basis of event information and narrowing down object modes.

Accordingly, the accuracy of anomaly preindication detection can be improved. This is equivalent to a case where, for example, three states, namely, A, B, and C are separately represented as illustrated in FIGS. 16 and 17, and by considering each state, a more compact set of learning data can be set as an object. As a result, oversight can be prevented and the accuracy of anomaly preindication detection can be improved. In addition, since learning data to be object data of similarity calculation can be limited, the load of calculating similarities can also be reduced.

Various methods can be applied to interpreting an event such as discerning an occurrence frequency at regular intervals, discerning an occurrence frequency of a combination of events (a joint event), or focusing on a particular event. Techniques such as text mining can also be utilized for event interpretation. For example, analytical methods such as an association rule or a sequential rule that adds a temporal axis element to the association rule can be applied. For instance, the anomaly explanation message illustrated in FIG. 1 indicates the basis of an anomaly being determined in addition to a result of event interpretation described above. Some examples are listed below.

The number of times an anomaly measure has exceeded a threshold for anomaly determination within a set period of time is equal to or greater than a set number of times.

The main reason that an anomaly measure has exceeded the threshold for anomaly determination is sensor signals “A” and “B”.

(a list of contribution ratios of the sensor signals to the anomaly is also represented)

An anomaly measure has exceeded the threshold for anomaly determination in synchronization with an event “C”.

The number of times a predetermined combination of events “D” and “E” has occurred within a set period of time is equal to or greater than a set number of times and an anomaly is determined.

### Sixth Embodiment

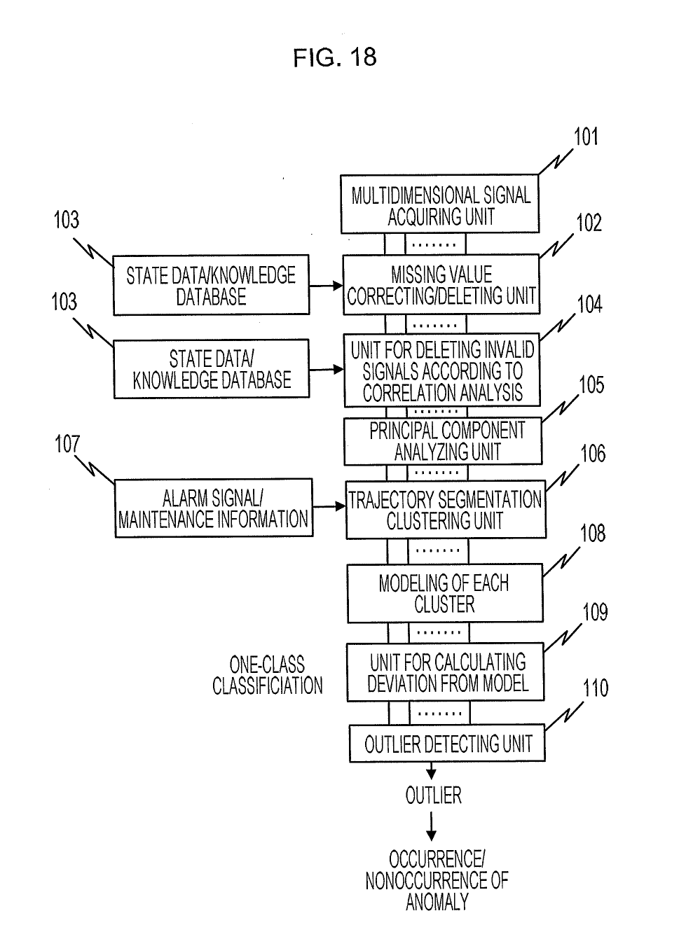

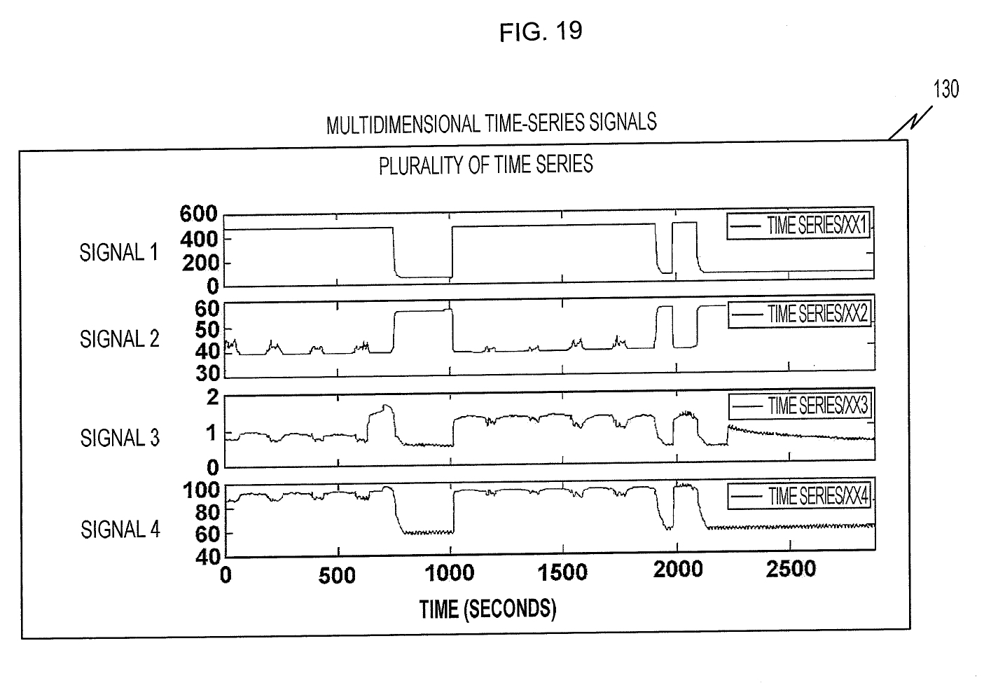

An anomaly detection method according to a sixth embodiment of the present invention is illustrated in FIG. 18. An example of object signals according to the sixth embodiment of the present invention is illustrated in FIG. 19. The object signals are a plurality of multidimensional time-series signals 130 such as those illustrated in FIG. 19. In this case, four types of signals, namely, series 1, 2, 3, and 4 are presented. In reality, signals need not necessarily be limited to four types and, in some cases, may number in the hundred or thousands.

Each signal corresponds to an output from a plurality of sensors provided in an object plant or facility. For example, a temperature of a cylinder, oil, cooling water, or the like, a pressure of oil or cooling water, a revolution speed of a shaft, a room temperature, an operating time, or the like are observed from various sensors at regular intervals such as several times each day or in real-time. In addition to representing an output or a state, a control signal (input) for controlling something is also conceivable. The control may be in the form of ON/OFF control or control to a constant value. Correlation among such data may either be high or low. All such signals may become objects. An occurrence/nonoccurrence of an anomaly is determined by examining such data. In this case, signals are to be treated as multidimensional time-series signals.

The anomaly detection method illustrated in FIG. 18 will now be described. First, a multidimensional time-series signal is acquired at a multidimensional signal acquiring unit 101. Next, since there are cases where the acquired multidimensional time-series signal contains a missing value, correction/deletion of a missing value is performed at the missing value correcting/deleting unit 102. Correcting missing values generally involves, for example, replacing previous and subsequent pieces of data or replacing a moving average. Deletion involves deleting an anomaly as data when a large number of data is simultaneously reset to 0. In some cases, correction/deletion of a missing value is performed on the basis of a state of a facility or knowledge of an engineer that is stored in advance in a DB that is named state data/knowledge 3.

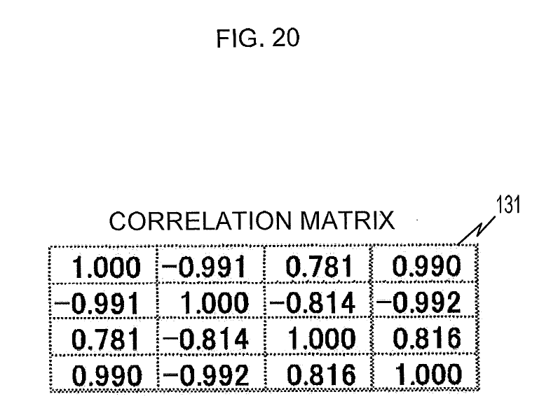

Next, with respect to corrected/deleted multidimensional time-series signals, deletion of an invalid signal according to correlation analysis is performed by a unit for deleting invalid signals according to correlation analysis 104. As exemplified in FIG. 20 by a correlation matrix 131, this involves performing correlational analysis on multidimensional time-series signals, and when similarity is extremely high such as in a case where there is a plurality of signals whose correlation value is near 1, the plurality of signals is assumed to be redundant and duplicate signals are deleted from the plurality of signals to retain signals other than the duplicate signals. In this case, similarly, deletion is performed on the basis of information stored in the state data/knowledge 3.

Next, dimension reduction of the data is performed at a principal component analyzing unit 5. In this case, by principal component analysis, an M-dimensional multidimensional time-series signal is linearly-transformed into an r-dimensional multidimensional time-series signal having dimensions. Principal component analysis generates an axis with maximum variance. KL transform may be performed instead. The number of dimensions r is decided on the basis of a value known as a cumulative contribution ratio calculated by arranging eigenvalues obtained by principal component analysis in a descending order and dividing eigenvalues added in a descending order of magnitude by a sum of all eigenvalues.

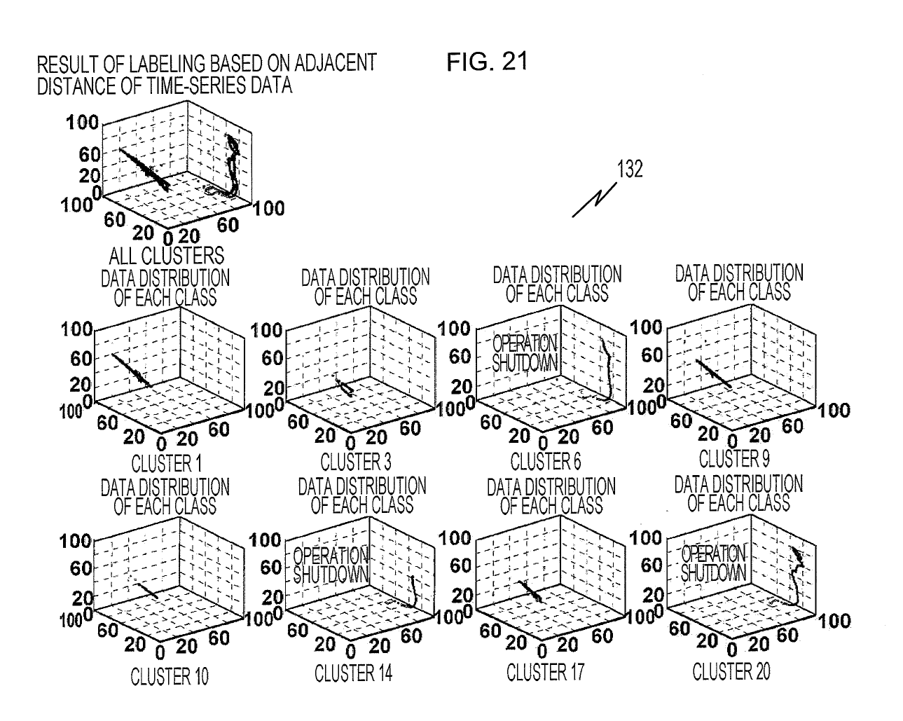

Next, trajectory segmentation clustering is performed on the r-dimensional multidimensional time-series signal by a trajectory segmentation clustering unit 106. FIG. 21 illustrates how such clustering 132 is performed. A three-dimensional representation (referred to as a feature space) on the upper-left of FIG. 21 is an r-dimensional multidimensional time-series signal after principal component analysis represented in three dimensions in which there is a high contribution ratio. It is shown that, in this condition, the state of the object facility is still observed as being complicated. The remaining eight three-dimensional representations in FIG. 21 illustrate trajectories tracked over time and subjected to clustering and represent respective clusters.

In clustering, if a predetermined threshold is exceeded by a distance between data over time, a different cluster is assumed, and if the threshold is not exceeded, a same cluster is assumed. Accordingly, it is shown that clusters are divided into clusters 1, 3, 9, 10, and 17 which are clusters in an operating state and clusters 6, 14, and 20 which are in a non-operating state. Clusters not illustrated such as cluster 2 are transitional. An analysis of these clusters reveals that in the operating state, trajectories move linearly, and in the non-operating state, trajectory movement is unstable. As shown, it is apparent that clustering by trajectory segmentation has certain advantages.

Classification into a plurality of states such as an operating state and a non-operating state can be performed.

(1) As shown by the operating state, these clusters can be expressed as a low-dimensional model such as a linear model.

By taking an alarm signal or maintenance information of a facility into consideration, clustering may be implemented in connection with such a signal or information. Specifically, information such as an alarm signal is to be added as an attribute to each cluster.

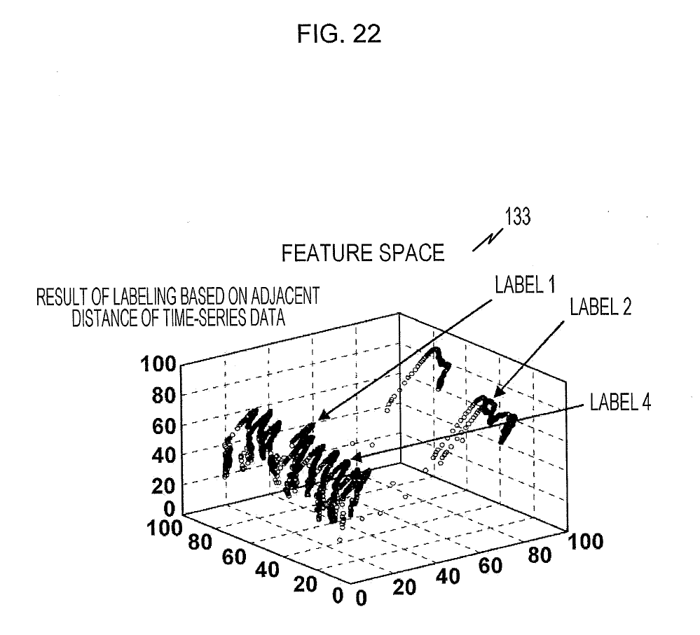

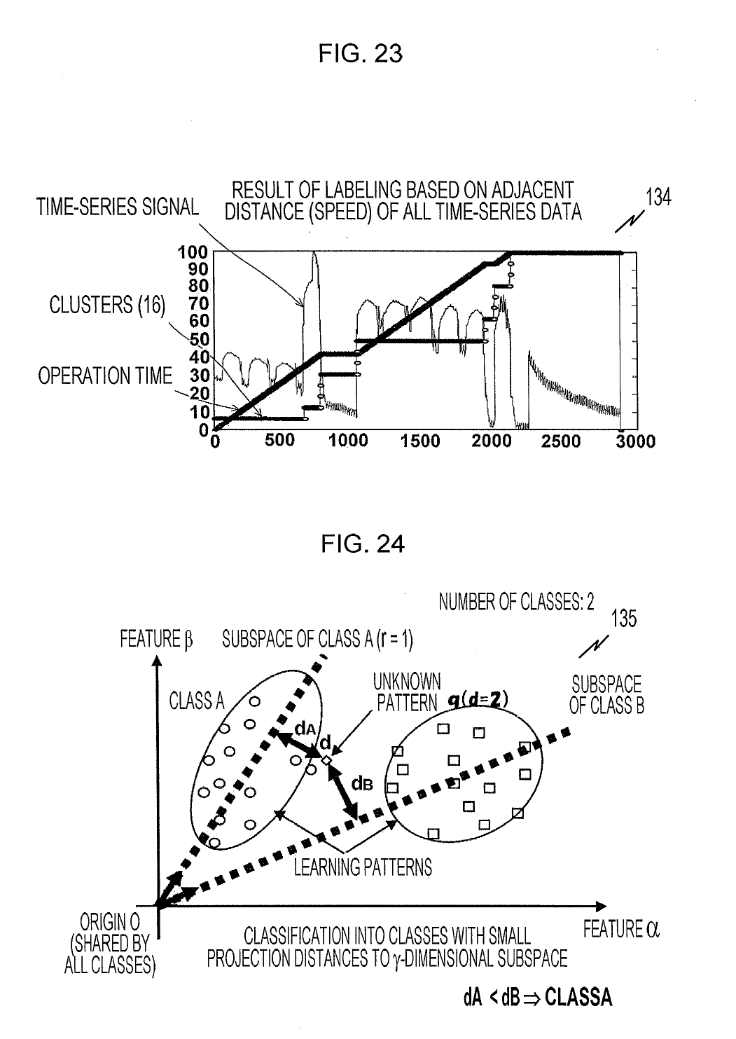

FIG. 22 represents another example of a state where labeling has been performed by clustering in a feature space. FIG. 23 illustrates a result 133 of labeling by clustering which is represented on a single time-series signal. In this case, it is shown that 16 clusters can be generated and that the time-series signal has been segmented into 16 clusters. Operation time (accumulated time) is also represented overlaid. Horizontal portions indicate non-operation. It is apparent that operating and non-operating states are accurately separated from each other.

In the trajectory clustering described above, caution is required when handling transition periods between clusters. In a transition period between segmented clusters, a cluster made up of a small amount of data may be segmented and extracted. FIG. 23 also shows a cluster 134 made up of a small amount of data that varies in steps in the direction of the ordinate. The cluster made up of a small amount of data represents a location among a transition period of sensor data where values vary significantly. As such, a determination must be made as whether to handle the cluster in conjunction with previous and subsequent clusters or individually. In most cases, such a cluster is favorably handled individually to be labeled as transitional data and accumulated as learning data. In other words, a transition period in which data varies over time is obtained by the trajectory segmentation clustering unit 106, whereby an attribute is added to transitional data and the transitional data is collected as learning data. It is needless to say that batch processing may be performed by consolidating with any of a previous and subsequent clusters.

Next, each cluster obtained by clustering is subjected to modeling in a low-dimensional subspace by a modeling unit 108. The modeling need not be limited to normal portions and the incorporation of an anomaly does not pose any problems. In this case, for example, modeling is performed by regression analysis. A general expression of regression analysis is as follows. “y” corresponds to an r-dimensional multidimensional time-series signal of each cluster. “X” denotes a variable for explaining y. “y˜” denotes a model. “e” denotes a deviation.

y: objective variable (r columns)
b: regression coefficient (1+p columns)
X: explanatory variable matrix (r rows, 1+p columns)
∥y−X∥ [symbol] min
b=(X′X)−1X′y (where ′ denotes transpose)
y˜=Xb=X(X′X)−1X′y (portion representing an influence of the explanatory variable)
e=y−y˜ (portion that cannot be approximated by y˜; a portion excluding the influence of the explanatory variable),
where rank X=p+1.

In this case, regression analysis is performed on the r-dimensional multidimensional time-series signal of each cluster with N pieces of data (N=0, 1, 2, . . . ) left out. For example, if N=1, then it is assumed that one type of anomalous signal is incorporated and a signal from which the one type of anomalous signal has been removed is modeled as “X”. If N=0, then entire r-dimensional multidimensional time-series signals are to be handled.

Besides regression analysis, a subspace method such as a CLAFIC method or a projection distance method may be applied. Subsequently, a deviation from the model is obtained by a unit for calculating deviation from model 109. FIG. 24 graphically illustrates a general CLAFIC method 135. A case of a 2-class, two-dimensional pattern is illustrated. A subspace of each class or, in this case, a subspace expressed as a one-dimensional straight line is obtained.

Generally, eigenvalue decomposition is applied to an autocorrelation matrix of data of each class and an eigenvector is obtained as a basis. Eigenvectors corresponding to several largest eigenvalues are to be used. When an unknown pattern q (newest observation pattern) is inputted, a length of an orthogonal projection to the subspace or a projection distance to the subspace is obtained. The unknown pattern (newest observation pattern) q is classified into a class whose orthogonal projection length is the longest or projection distance is the shortest.

In FIG. 24, the unknown pattern q (newest observation pattern) is classified into class A. With the multidimensional time-series signal illustrated in FIG. 19, since a normal part is basically set as an object, the problem becomes a problem of one-class classification (illustrated in FIG. 18). Therefore, class A is set as the normal part, and a distance from the unknown pattern q (newest observation pattern) to class A is obtained as the deviation. If the deviation is large, a determination of outlier is made. With such a subspace method, even if a certain amount of anomalous values is incorporated, the influence of such anomalous values is mitigated once dimension reduction is applied and a subspace is defined. This is an advantage of applying the subspace method.

Moreover, with the projection distance method, a center of gravity of each class is used as an origin. An eigenvector obtained by applying KL expansion to a covariance matrix of each class is used as a basis. While many subspace methods have been devised, outlyingness can be calculated as long as a measure of distance is provided. Moreover, outlyingness can also be determined in a case of density on the basis of a magnitude of density. The CLAFIC method obtains an orthogonal projection length and is therefore a measure of similarity.

As shown, a distance or a similarity is calculated in a subspace in order to evaluate outlyingness. Since subspace methods such as the projection distance method are distance-based classifiers, vector quantization for updating dictionary patterns and metric learning for learning distance functions can be used as a learning method in a case where anomalous data can be utilized.

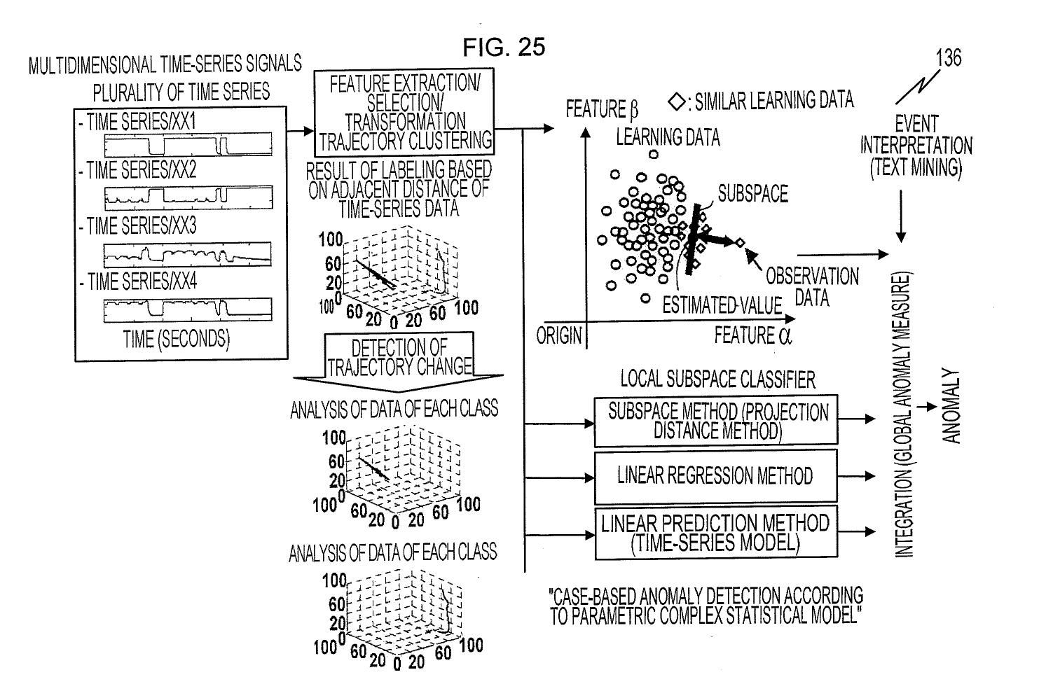

In addition, a method referred to as a local subspace classifier can also be applied in which k multidimensional time-series signals near an unknown pattern q (newest observation pattern) are obtained, a linear manifold having a nearest neighbor pattern of each class as an origin is generated, and the unknown pattern is classified into a class having a minimum projection distance to the linear manifold (refer to boxed description regarding a local subspace classifier provided in FIG. 25). The local subspace classifier is also a type of a subspace method.

The local subspace classifier is to be applied to each cluster subjected to the clustering described earlier. k denotes a parameter. In the same manner as described earlier, with anomaly detection, since the problem becomes a problem of one-class classification, class A containing the majority of data is set as the normal part and a distance from the unknown pattern q (newest observation pattern) to class A is obtained as the deviation.

With this method, for example, an orthogonally-projected point from the unknown pattern q (newest observation pattern) to a subspace formed using the k multidimensional time-series signals can be calculated as an estimated value (data referred to as an estimated value in the boxed description regarding a local subspace classifier provided in FIG. 25). In addition, the k multidimensional time-series signals can be rearranged in a descending order of proximity to the unknown pattern q (newest observation pattern) and weighted in inverse proportion to the distance to calculate an estimated value of each signal. Estimate values can similarly be calculated using a projection distance method and the like.

While normally only one type of parameter k is defined, employing several different parameters k is more effective because object data can now be selected according to similarity and a comprehensive determination 136 can be made from results thereof. Since the local subspace classifier is performed on selected data in a cluster, even if a certain amount of anomalous values is incorporated, the influence of such anomalous values is significantly mitigated once a local subspace is defined.

Alternatively, k multidimensional time-series signals near an unknown pattern q (newest observation pattern) may be obtained independently of clusters, a cluster to which a highest number of multidimensional time-series signals among the k multidimensional time-series signals belong may be determined as being the cluster to which the unknown pattern q belongs, and L multidimensional time-series signals near the unknown pattern q may be once again obtained from learning data to which the cluster belongs, whereby the local subspace classifier can be applied using the L multidimensional time-series signals.

The concept of “local” in the local subspace classifier is also applicable to regression analysis. In other words, with respect to “y”, k multidimensional time-series signals near an unknown observation pattern q is be obtained, and “y˜” is obtained with y as a model to calculate a deviation “e”.

Moreover, when simply considering a problem of one-class classification, a classifier such as a one-class support vector machine can also be applied. In this case, kernelization such as a radial basis function for mapping onto a higher-order space can be used. With a one-class support vector machine, a side nearer to the origin becomes an outlier or, in other words, an anomaly. However, while a support vector machine is capable of accommodating high-dimensional feature amounts, there is also a disadvantage in that the amount of calculation becomes enormous as the number of pieces of learning data increases.

In consideration thereof, methods such as “IS-2-10 Takekazu Kato, Mami Noguchi, Toshikazu Wada (all of Wakayama University), Kaoru Sakai, and Shunji Maeda (all of Hitachi, Ltd.); Pattern no Kinsetsusei ni Motozuku 1 class Shikibetsuki (in Japanese) [One-Class Classifier Based on Pattern Proximity]”, presented at MIRU 2007 (Meeting on Image Recognition and Understanding 2007) can be applied. In this case, there is an advantage that the amount of calculation does not become enormous even if the number of pieces of learning data increases.

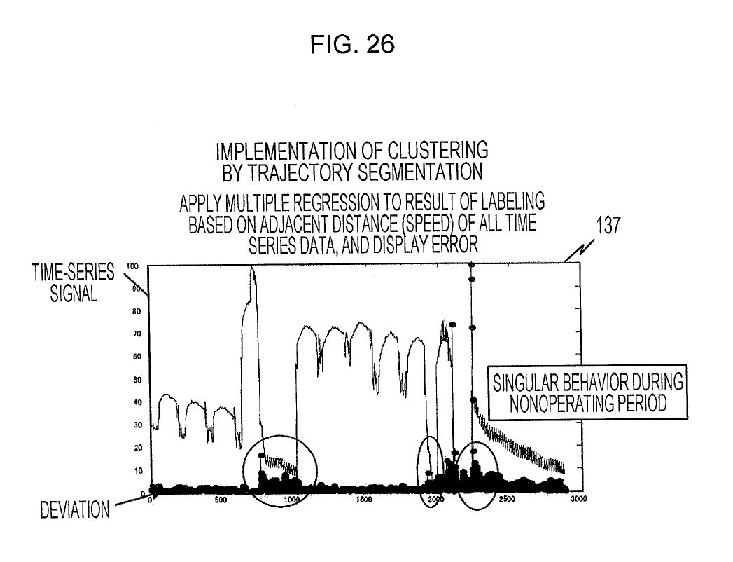

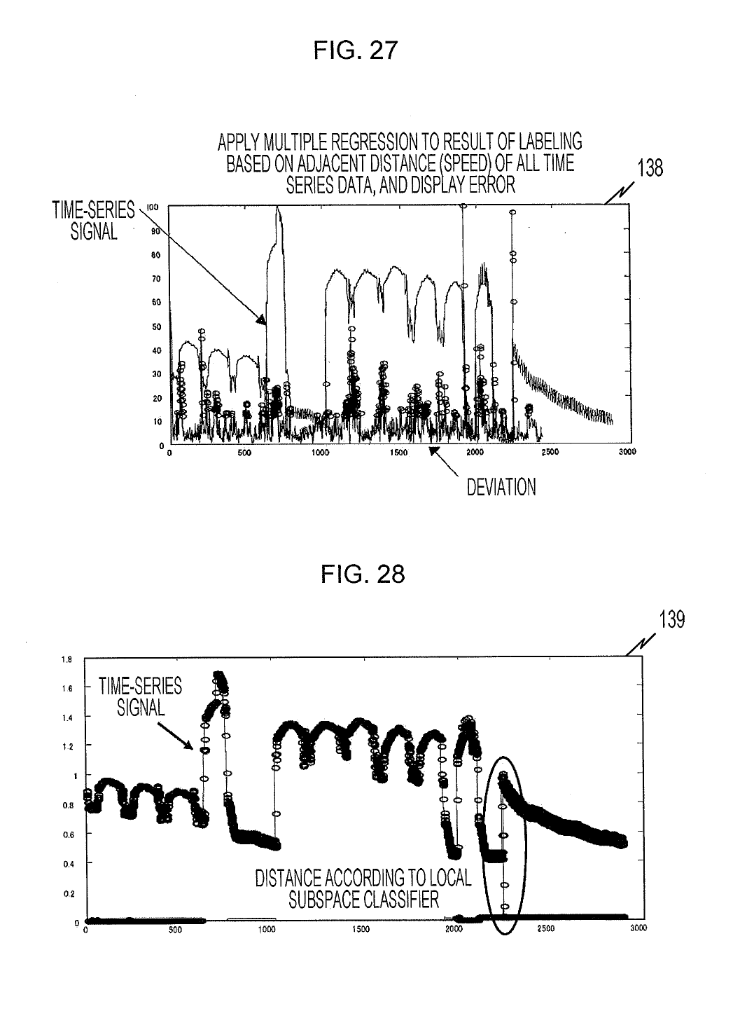

Next, taking regression analysis as an example, an experimental case will be described. FIG. 26 presents an example 137 of N=0 illustrating deviations between a model of an r-dimensional multidimensional time-series signals made by linear regression analysis and actual measured values. FIG. 27 presents, as reference, an example 138 of a case where clustering by trajectory segmentation is not implemented. In the case of FIG. 26, deviation is large during non-operating sections and when a time-series signal shows a vibrational behavior during operating sections. Finally, an outlier is obtained by an outlier detecting unit 110. In this case, a magnitude in comparison to a threshold is checked. Since a detected anomalous signal has already been subjected to principal component analysis, by inversely transforming the detected anomalous signal, it is possible to verify at what proportion the original signal had been synthesized to be determined as being an anomaly.

As shown, since expressing a multidimensional time-series signal by a low-dimensional model with a focus on clustering by trajectory segmentation enables a complicated state to be broken down and expressed by a simple model, an advantage is gained in that phenomena can be understood more easily. In addition, since a model is to be made, a complete set of data need not be exhaustively prepared as is the case of the method proposed by Smart Signal Corporation. An advantage is that missing data is permissible.

Next, an application example 139 of the local subspace classifier is illustrated in FIG. 28. In this example, a signal is divided into first and second halves (in accordance with a method of verification referred to as cross validation), the respective halves are set as learning data, and distances to remaining data are obtained. A parameter k is set to 10. A stable result can be obtained by adopting several “k”s and making a majority decision thereof (on the basis of a concept similar to a method referred to as bagging, to be described later). The local subspace classifier is advantageous in that N pieces of data are automatically left out. In the illustrated application example, irregular behavior during non-operation has been detected.

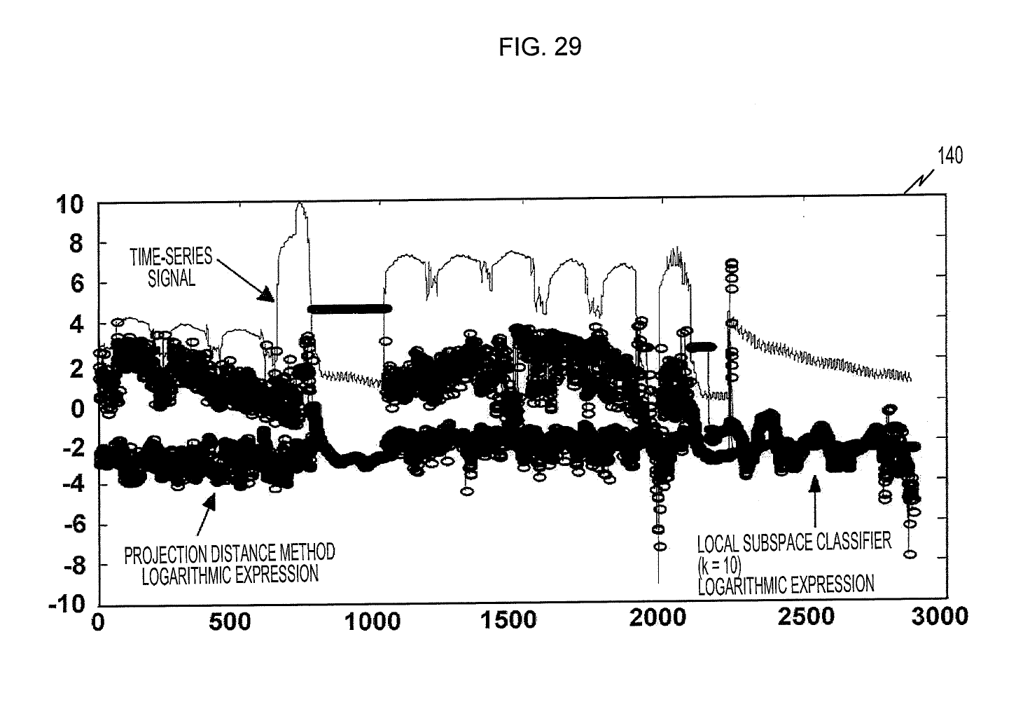

In the example described above, while the need for clustering is mitigated, clusters other than a cluster to which observation data belongs may be set as learning data, whereby the local subspace classifier may be applied to the learning data and the observation data. According to this method, a deviance from another cluster can be evaluated. The same applies to the projection distance method. Examples 140 thereof are illustrated in FIG. 29. Clusters other than the cluster to which the observation data belongs are set as learning data. This concept is effective in a case where there are consecutive pieces of similar data such as time-series data because most similar pieces of data can be eliminated from a “local” region. Moreover, while the N pieces of data to be left out has been described as feature amounts (sensor signals), data in a direction of a temporal axis may be left out instead.

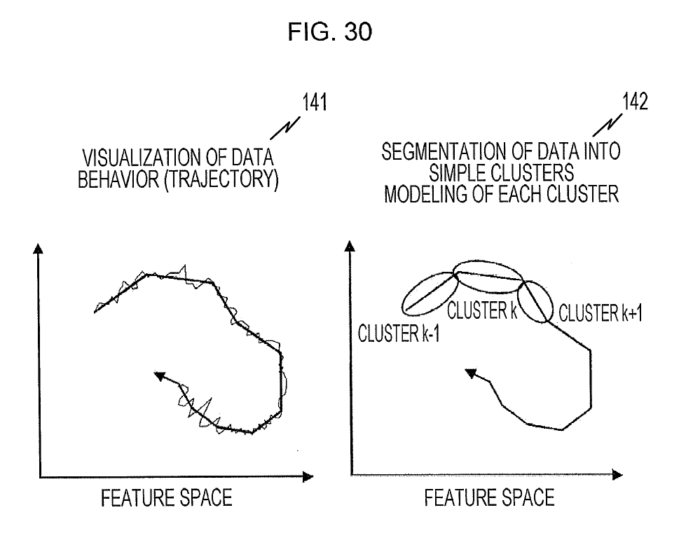

Next, forms of expression of data will be described with reference to several drawings. FIG. 30 illustrates some examples. Diagram 141 on the left-hand side of FIG. 30 is a two-dimensional representation of an r-dimensional time-series signal after principal component analysis. This is an example of visualization of data behavior. Diagram 142 on the right-hand side of FIG. 30 illustrates clusters after implementing clustering by trajectory segmentation. This is an example in which each cluster is expressed by a simple low-dimensional model (in this case, a straight line).

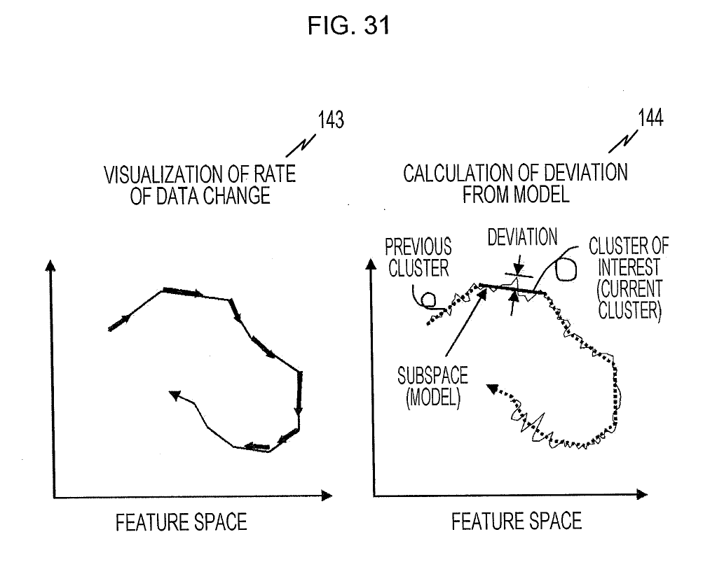

Diagram 143 on the left-hand side of FIG. 31 is an example illustrated so that speeds at which data moves can be perceived. By applying wavelet analysis, to be described later, even speed or, in other words, frequency can be analyzed and handled as a multivariate. Diagram 144 on the right-hand side of FIG. 31 is an example illustrated such that deviations from the model illustrated in diagram 142 on the right-hand side of FIG. 30 can be perceived.

Diagram 90 on the left-hand side of FIG. 16 is another example. This is an example illustrating a model after merging of clusters determined as being similar on the basis of a distance criterion or the like (the drawing illustrates merging of adjacent clusters) as well as deviations from the model. Diagram 91 on the right-hand side of FIG. 16 expresses states. Three types of states, namely, A, B, and C, are represented separately. By considering separate states, a change in state A or the like can now be illustrated as seen in the diagram on the left-hand side of FIG. 17.

Considering the example illustrated in FIG. 23, different behaviors are manifested between before and after non-operation even with a same operating state, which can now be expressed in a feature space. Diagram 93 on the right-hand side of FIG. 17 illustrates a change from a model (low-dimensional subspace) obtained from previous learning data and enables a change in state to be observed. As described, by processing data, presenting the processed data to a user, and visualizing a current status, better understanding may be promoted.

### Seventh Embodiment

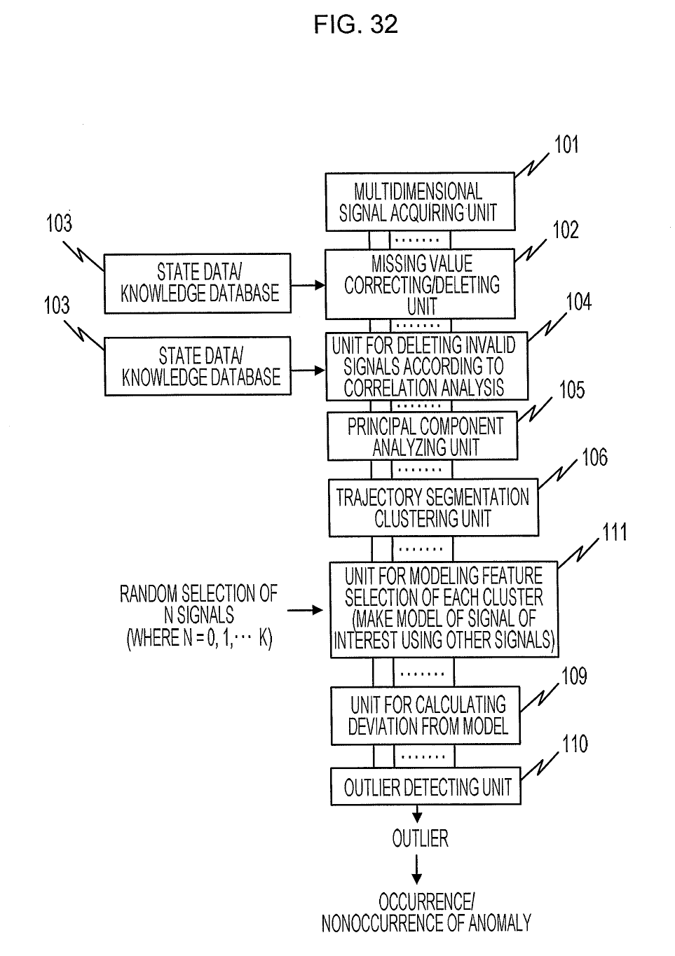

Next, another embodiment of the present invention, a seventh embodiment, will be described. Blocks already described will be omitted. FIG. 32 illustrates an anomaly detection method. Here, at a modeling unit 111 for selecting a feature amount of each cluster, a randomly-set number of r-dimensional multidimensional time-series signals are selected for each cluster.

Random selection offers the advantages of:
(1) properties not visible when using all signals become evident;
(2) invalid signals are removed; and
(3) calculations take less time than all combinations.

In addition, selection is also conceivable in which a randomly-set number of r-dimensional multidimensional time-series signals are selected in a direction of a temporal axis. While units of clusters may be considered, in this case, a cluster is sectioned and a predetermined number of sections are randomly selected.

### Eighth Embodiment

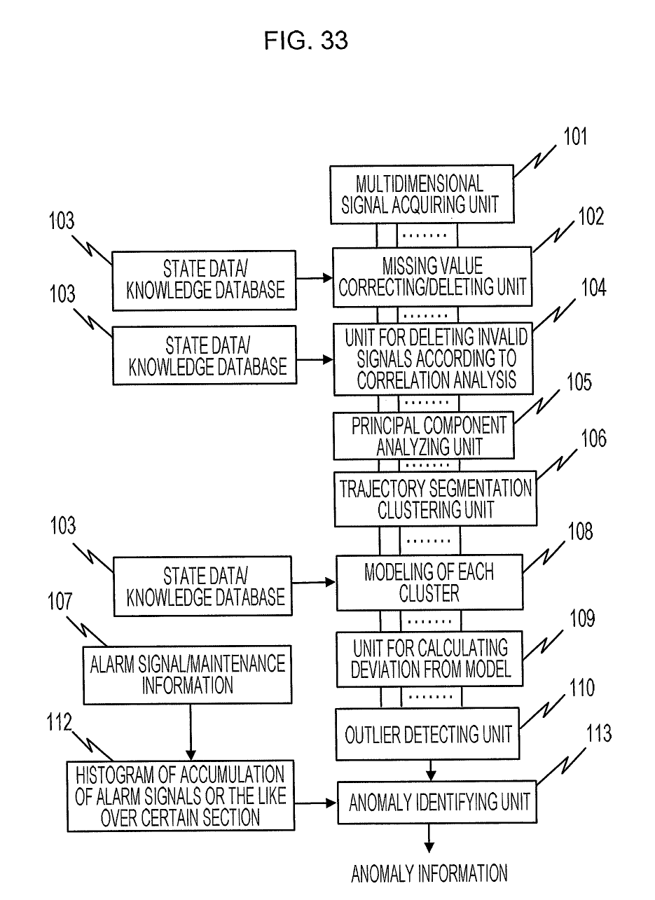

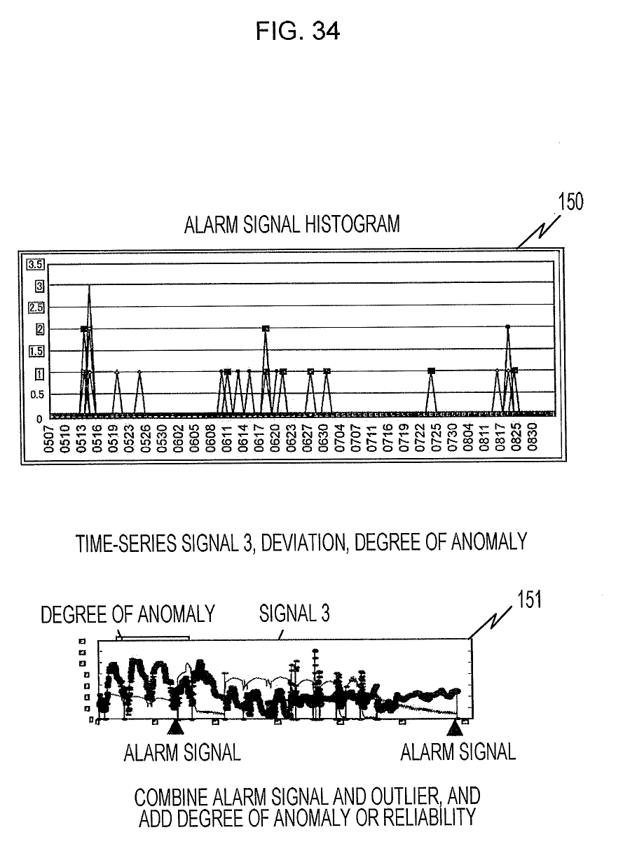

FIG. 33 illustrates another embodiment, namely, an eighth embodiment. A unit 112 has been added which processes alarm signal/maintenance information 107 and creates a cumulative histogram of a certain section. As illustrated in an upper diagram in FIG. 34, an occurrence history of alarm signals is acquired. A histogram 150 thereof is then displayed. It is easily imaginable that sections with high frequency have a high degree of anomaly. Therefore, as illustrated in a lower diagram 151 in FIG. 34, by also taking into consideration frequencies in the histogram, an anomaly identifying unit 113 illustrated in FIG. 16 combines an alarm signal with an outlier to add a degree of anomaly or reliability and to perform anomaly determination.

### Ninth Embodiment

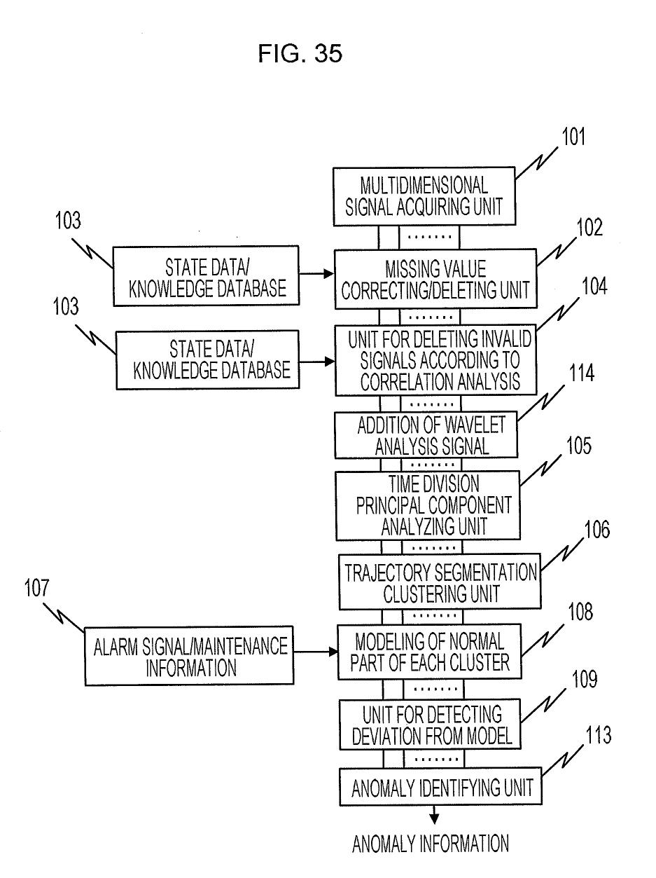

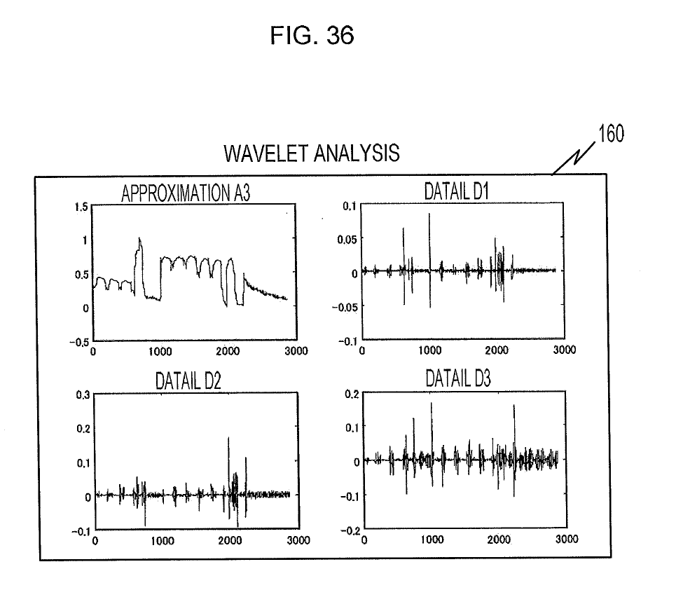

FIG. 35 illustrates another embodiment, namely, a ninth embodiment. This is an example to which wavelet (transform) analysis has been added. A wavelet analysis signal adding unit 14 performs a wavelet analysis 160 illustrated in FIG. 36 on an M-dimensional multidimensional time-series signal, and adds the signals to the M-dimensional multidimensional time-series signal. The signals can also replace the M-dimensional multidimensional time-series signal. An anomaly is detected by a classifier such as a local subspace classifier with respect to a multidimensional time-series signal that has been added or replaced in this manner.

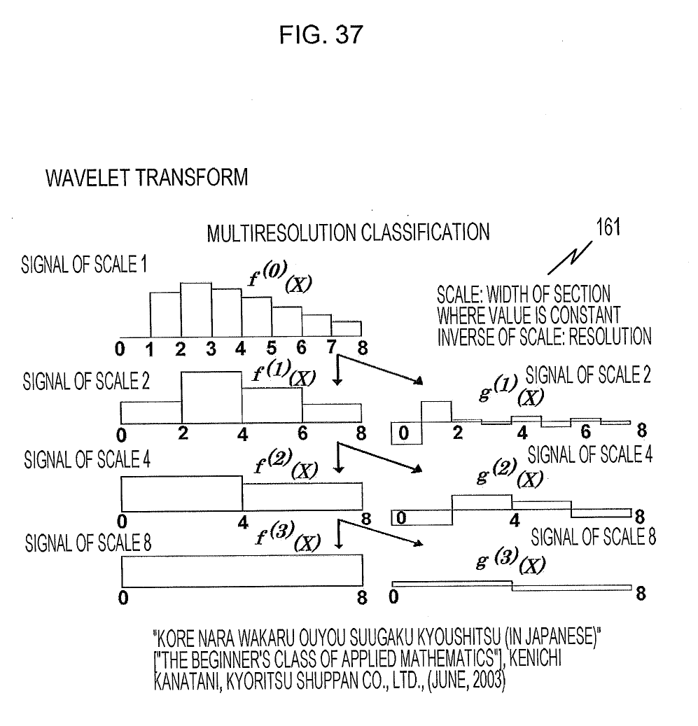

Moreover, an upper-left diagram in FIG. 36 corresponds to a signal of a scale 1 in a wavelet transform 161 in FIG. 37 to be described later, an upper-right diagram of the wavelet analysis 160 in FIG. 36 corresponds to a fluctuation of a scale 8 in FIG. 37 to be described later, a lower-left diagram of the wavelet analysis 160 in FIG. 36 corresponds to a fluctuation of a scale 4 in FIG. 37, and a lower-right diagram of the wavelet analysis 160 in FIG. 36 corresponds to a fluctuation of a scale 2 in FIG. 37.

A wavelet analysis provides a multiresolution representation. A wavelet transform is illustrated in FIG. 37. A signal of scale 1 is the original signal. The signal is sequentially added to an adjacent signal to create a signal of scale 2, and a difference from the original signal is calculated to create a fluctuation signal of scale 2. By repeating this sequentially, finally, a signal of a certain value of scale 8 and a fluctuation signal thereof are obtained. Ultimately, the original signal can be broken down into respective fluctuation signals of scales 2, 4, and 8 and a direct current signal of scale 8. Therefore, such respective fluctuation signals in scales 2, 4, and 8 are considered to be new characteristic signals and added to a multidimensional time-series signal.

With a nonstationary signal such as a pulse or an impulse, a frequency spectrum obtained by performing a Fourier transform spreads over all ranges and makes it difficult to extract features from individual signals. Wavelet transform that enables a temporally localized spectrum to be obtained is convenient in cases such as a chemical process which involves data including a large number of nonstationary signals such as pulses and impulses.

In addition, in a system having a first order lag, it is difficult to observe a pattern using only a time-series state. However, since identifiable features may be manifested on temporal/frequency regions, wavelet transform is often effective.

The application of wavelet analysis is described in detailed in “Wavelet Kaiseki no Sangyo-Ohyou (in Japanese) [Industrial Application of Wavelet Analysis] (2005)” written by Seiichi Shin, edited by The Institute of Electrical Engineers of Japan, and published by Asakura Publishing Co., Ltd. A wide application range includes diagnosis of a control system of a chemical plant, anomaly detection in controlling a heating and cooling plant, anomaly monitoring in a cement pyroprocess, and controlling a glass melting furnace.

A difference between the present embodiment and conventional art is that wavelet analysis is treated as a multiresolution representation and that information of an original multidimensional time-series signal is exposed by wavelet transform. Moreover, by handling such information as multivariates, early detection is enabled from stage where an anomaly is still minute. In other words, early detection as a preindication can be achieved.

### Tenth Embodiment

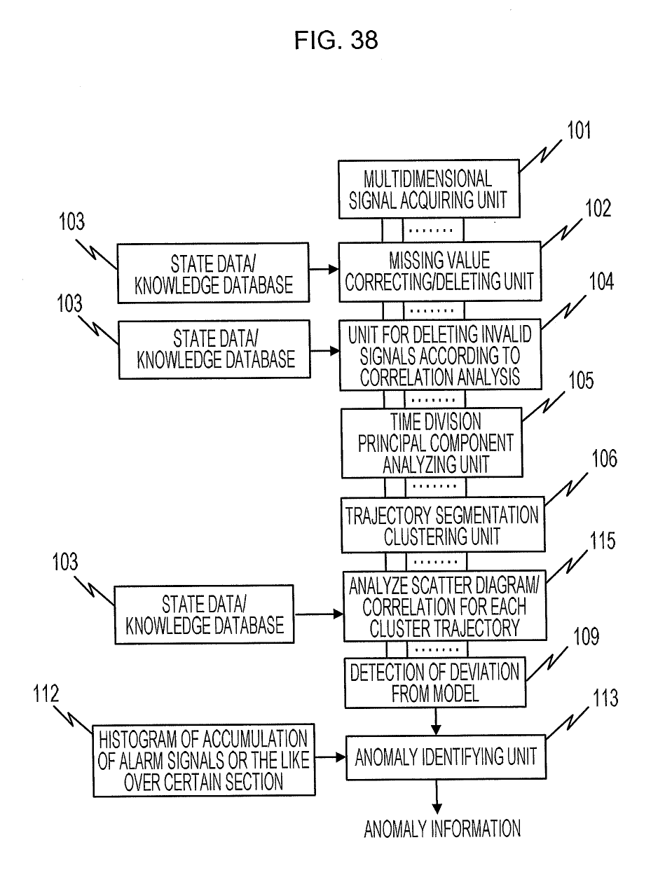

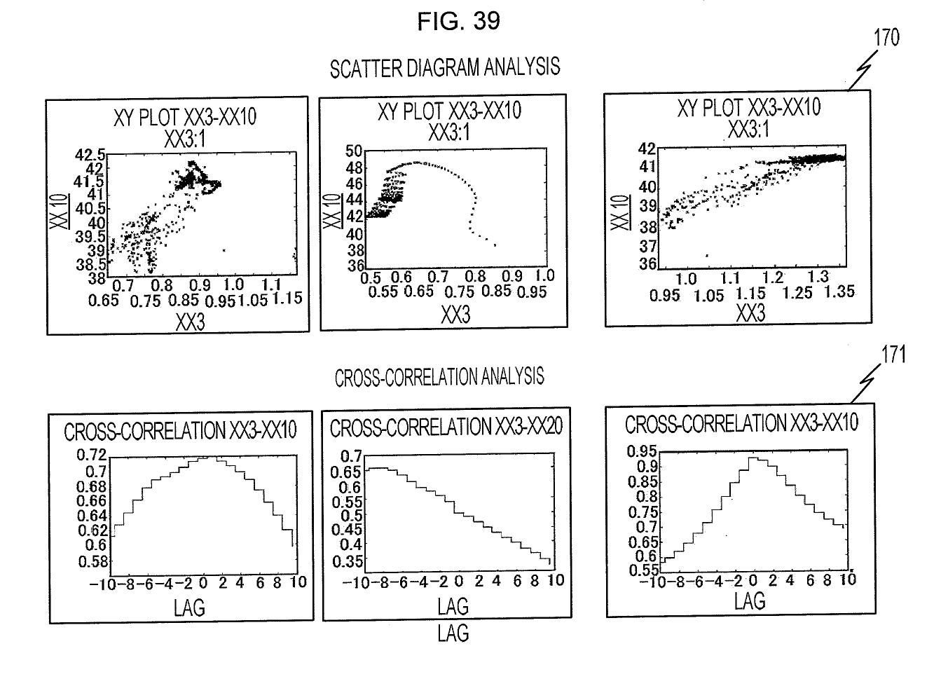

FIG. 38 illustrates another embodiment, namely, a tenth embodiment. This is an example to which a scatter diagram/correlation analyzing unit 115 has been added. FIG. 39 illustrates an example of scatter diagram analysis 170 and cross-correlation analysis 171 performed on r-dimensional multidimensional time-series signals. With the cross-correlation analysis 171 illustrated in FIG. 39, a lag of delay is taken into consideration. A position of a maximum value of a cross-correlation function is normally referred to as a lag. According to this definition, a time lag between two phenomena is equal to a lag in a cross-correlation function.

A positivity or negativity of a lag is determined by which of the two phenomena occurs first. While a result of such scatter diagram analysis or cross-correlation analysis represents a correlation between time-series signals, the result can also be utilized in characterizing each cluster and may provide an index for determining a similarity between clusters. For example, a similarity between clusters is determined on the basis of a degree of coincidence of amounts of lag. Accordingly, merging of similar clusters as illustrated in FIG. 30 can be performed. Modeling is performed using the merged data. Moreover, merging may also be performed using other methods.

### Eleventh Embodiment

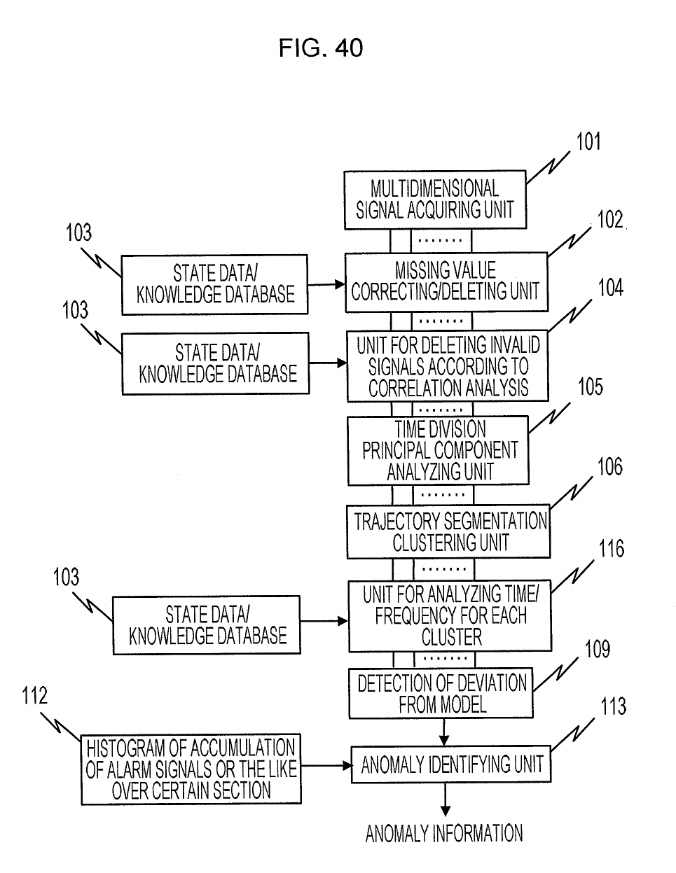

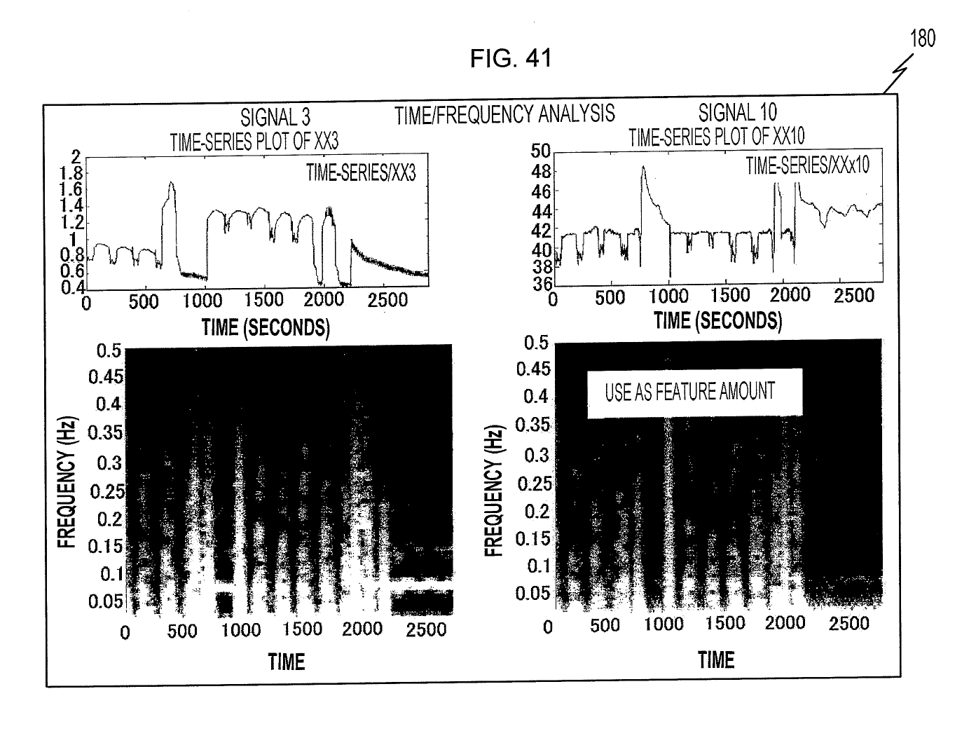

FIG. 40 illustrates another embodiment, namely, an eleventh embodiment. This is an example to which a time/frequency analyzing unit 116 has been added. FIG. 41 illustrates an example of time/frequency analysis 180 performed on r-dimensional multidimensional time-series signals. By performing the time/frequency analysis 180 or a scatter diagram/correlation analysis, these signals can also be added to or replace M-dimensional multidimensional time-series signals.

### Twelfth Embodiment

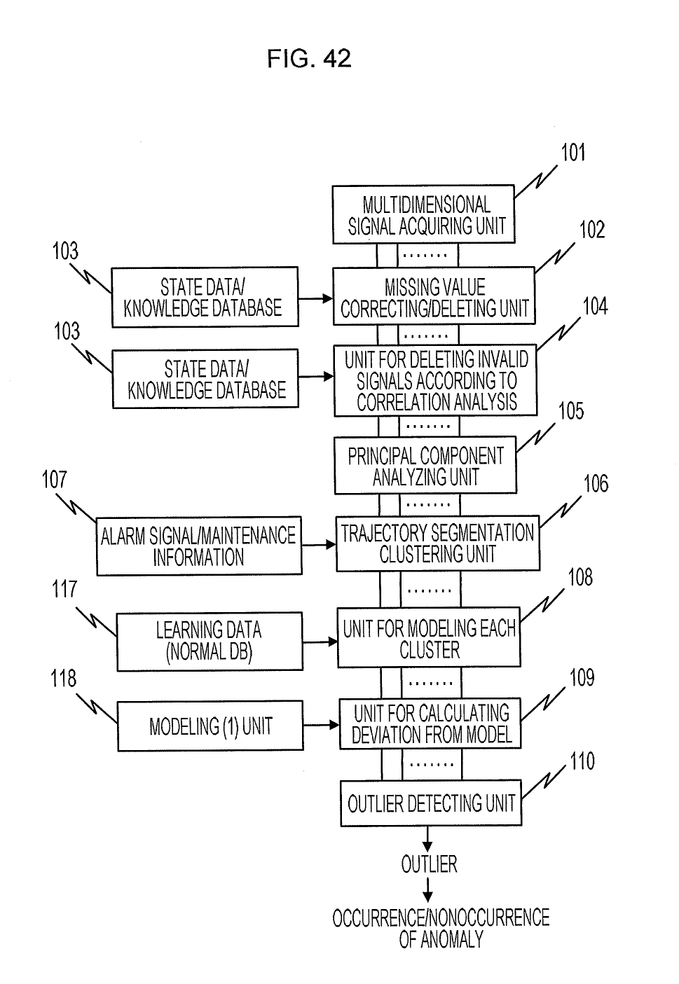

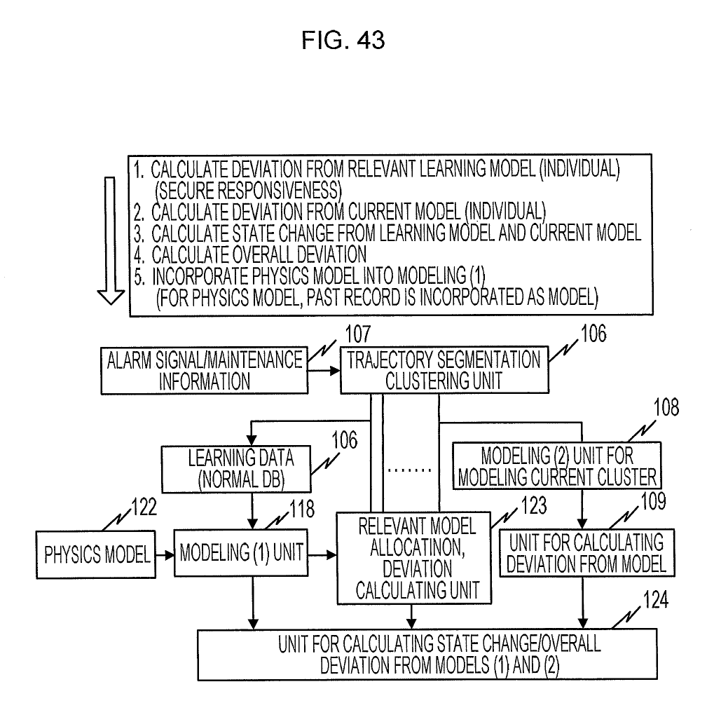

FIG. 42 illustrates another embodiment, namely, a twelfth embodiment. This is an example in which a learning data DB 117 and modeling (1) 118 have been added. Details thereof are illustrated in FIG. 43. Through modeling (1) 118, modeling is performed on learning data by using each piece of data as a plurality of models, determining similarities with observation data and applying the models, and calculating deviations from the observation data. Modeling (2) 108 is similar to FIG. 16 and is used to calculate a deviation from a model obtained from observation data.

Subsequently, using respective deviations from modeling (1) and (2), a state change is calculated and a total deviation is calculated. In this case, while modeling (1) and (2) can be treated equally, weighting may be applied. In other words, if learning data is considered to be a basis, a weight of a model (1) is increased, and if observation data is considered to be a basis, a weight of a model (2) is increased.

In accordance with the representation illustrated in FIG. 31, by comparing subspace models constituted by the model (1) between clusters, if the clusters originally have a same state, then a state change can be ascertained. In addition, if a subspace model of the observation data has moved from the original state, a state change can be identified. If the state change represents an intention to replace parts or the like or, in other words, if a designer is aware of the state change and the state change should be allowed, then the weight of the model (1) is reduced and the weight of the model (2) is increased. If the state change is unintended, then the weight of model (1) is increased.

For example, using a parameter α as the weight of the model (1), a formulation expressed as

α×model(1)+(1×α)×model(2)

is obtained.

Forgetting modeling may also be adopted in which the older the model (1), the smaller the weight thereof. In this case, emphasis is to be placed on models based on recent data.

In FIG. 43, a physics model 122 is a model that simulates an object engine or the like through simulation. When sufficient knowledge on the object is available, since the object engine or the like can be expressed as a discrete-time (non-) linear state space model (expressed as a state equation or the like), an intermediate value or an output thereof can be estimated. Therefore, according to this physics model, anomaly detection can now be performed on the basis of a deviation from the model.

It is obvious that the learning data model (1) can also be corrected according to the physics model. Alternatively, in an opposite manner, the physics model can be corrected according to the learning data model (1). As a modification of a physics model, findings as a past record can also be incorporated as a physics model. Transition of data accompanying an occurrence of an alarm or replacement of parts can also be incorporated into a physics model. Alternatively, learning data (individual pieces of data, position of a center of gravity, or the like) may be relocated in accordance with an occurrence of an alarm or replacement of parts.

Moreover, as illustrated in FIGS. 18 to 42, a statistical model is mainly used with respect to the physics model illustrated in FIG. 43 because a statistical model is effective in cases where understanding of a data generating process is insufficient. A distance or a similarity can be defined even if a data generating process is unclear. Even in a case where the object is an image, a statistical model is effective when an image generating process is unclear. A physics model 122 can be utilized when even a small amount of knowledge regarding the object can be used.

While a facility such as an engine has been described as an object in the respective embodiments above, no particular restrictions need be made on objects as long as the signals are time-series signals or the like. The respective embodiments are also applicable to anthropometric data. According to the present embodiment, cases with a large number of states or transitions can also be accommodated.

In addition, the various functions described in the embodiments such as clustering, principal component analysis, and wavelet analysis need not always be implemented and may be carried out as appropriate according to characteristics of an object signal.

For clustering, it is needless to say that, in addition to temporal trajectories, methods in the field of data mining such as an EM (Expectation-Maximization) algorithm for a mixture distribution and k-means clustering can be used. As for obtained clusters, a classifier may be applied to each cluster. Alternatively, the obtained clusters may be grouped and a classifier may be applied to each group.

A simplest example is to divide clusters into clusters to which daily observation data belongs and into other clusters (this corresponds to current data that is data of interest and past data that is temporally-previous data illustrated in a feature space on the right-hand side of FIG. 31). In addition, for sensor signal (feature amount) selection, existing methods such as a wrapper method (for example, removing most unwanted features one by one from a state where all feature amounts are present by backward stepwise selection) can be applied.

Furthermore, as illustrated in FIG. 6, a plurality of classifiers can be prepared and a majority decision of the classifiers can be made. A plurality of classifiers is used because classifiers respectively obtain outlyingness using different criteria on different object data ranges (dependent on segmentation or integration thereof) and minute differences occur among results. Therefore, the classifiers are to be configured according to a high-level criterion such as stabilization by making a majority decision, outputting an anomaly occurrence when an anomaly is detected at any of the classifiers on the basis of OR (detection of a maximum value in a case of an outlier itself or, in other words, in a case of multiple values) logic in an attempt to detect every single anomaly, and outputting an anomaly occurrence when anomalies are simultaneously detected at all of the classifiers on the basis of AND (detection of a minimum value in a case of multiple values) logic in an attempt to minimize erroneous detection. Moreover, it is needless to say that the integration described above can also be performed by taking information such as maintenance information including an alarm signal, parts replacement, and the like into consideration.

A same classifier may be used for all classifiers h1, h2, . . . to enable learning by varying object data ranges (dependent on segmentation or integration thereof). For example, representative methods of pattern recognition such as bagging and boosting can also be applied. By applying such methods, a higher accuracy rate of anomaly detection can be secured.

In this case, bagging refers to a method in which with duplicates in N pieces of data permitted, K pieces of data are retrieved (restoration/extraction), a first classifier h1 is created on the basis of the K pieces, K pieces of data are similarly retrieved with duplicates in N pieces of data permitted, a second classifier h2 is created on the basis of the K pieces (which differs in content from the first classifier), and by repeating this procedure until several classifiers are created from different groups of data, a majority decision is made when the classifiers are actually used as discriminators.

With boosting (a method referred to as Adaboost), an equal weight 1/N is first allocated to N pieces of data, a first classifier h1 learns by using all N pieces of data, accuracy rates are checked for the N pieces of data after learning, and a reliability β1 (>0) is obtained on the basis of the accuracy rates. The weights of data for which the first classifier had been correct are multiplied by exp (−β1) to reduce the weights, while the weights of data for which the first classifier had not been correct are multiplied by exp (β1) to increase the weights.

For a second classifier h2, weighted learning is performed using all N pieces of data, a reliability β2 (>0) is obtained, and the weights of data are updated. The weights of data for which the two classifiers had both been correct become lighter while the weights of data for which the two classifiers had both been wrong become heavier. Subsequently, this procedure is repeated until M classifiers are made, whereby when the classifiers are actually used as discriminators, a reliability-based majority decision is made. By applying such methods to cluster groups, an improvement in performance can be expected.

FIG. 25 illustrates a configuration example of anomaly detection as a whole including the classifiers illustrated in FIG. 6. A high classification rate is achieved by trajectory clustering, feature selection and the like, followed by ensemble learning. A linear prediction method is a method of predicting data at a next time of day using pieces of time-series data up to the present, and expressing the predicted value as a linear combination of pieces of data up to the present and making a prediction on the basis of a Yule Walker equation. An error from the predicted value is a deviance.

While a method of integrating classifier outputs is as described earlier, there are many combinations as to which classifier is to be applied to which cluster. For example, a local subspace classifier is applied to clusters that differ from observation data to discern an outlyingness from the different clusters (an estimated value is also calculated), while a regression analysis method is applied to clusters that are the same as the observation data to discern outlyingness from the cluster of the observation data.

Subsequently, outputs of the classifiers can be integrated to perform an anomaly determination. An outlyingness from other clusters can also be discerned by a projection distance method or a regression analysis method. An outlyingness from the cluster of the observation data can be discerned by a projection distance method. When an alarm signal can be utilized, depending on a level of severity of the alarm signal, a cluster not assigned a severe alarm signal can be set as an object.

A similarity among clusters can be determined, whereby similar clusters can be integrated to be set as an object. The integration of classifier outputs may be performed by adding outliers or by a scalar transformation process such as maximum/minimum and OR/AND, or classifier outputs may be treated as being multidimensional in a vector-like manner. It is needless to say that scales of classifier outputs are to be conformed to each other as much as possible.

In regards to how to provide a relation with the cluster described above, further, anomaly detection of an initial report may be performed on other clusters, and once data regarding the cluster is collected, anomaly detection of a secondary report may be performed on the cluster. In this manner, awareness of a client can be promoted. As shown, the present embodiment may be described as an embodiment which places a greater focus on signal behavior in a relationship with an object cluster group.

Overall effects related to several of the embodiments described above will now be further elaborated. For example, a company owning a power-generating facility desires to reduce device maintenance cost and, to this end, performs device inspections and parts replacement within a warranty period. This is referred to as time-based facility maintenance.

However, there is a recent trend to switch to condition-based maintenance in which parts replacement is performed in accordance with the conditions of devices. Performing condition maintenance requires collecting normal and anomalous data of devices, and the quantity and quality of the data determines the quality of condition maintenance. However, in many cases, anomalous data is rarely collected and the bigger the facility, the more difficult it is to collect anomalous data. Therefore, it is important to detect outliers from normal data. According to several embodiments described above, in addition to direct benefits such as

In addition to such direct benefits as

(1) anomalies can be detected from normal data,
(2) highly accurate anomaly detection can be achieved even when data collection is incomplete, and
(3) even when anomalous data is included, the influence of such anomalous data can be tolerated, such secondary benefits as
(4) phenomena become more easily understood by users,
(5) knowledge of engineers can be utilized, and
(6) physics models can be used concurrently may be provided.

### INDUSTRIAL APPLICABILITY

The present invention can be utilized as anomaly detection for a plant or a facility.

### REFERENCE SIGNS LIST

1 anomaly detection system
2 operation PC
11 multidimensional time-series signal acquiring unit
12 feature extracting/selecting/transforming unit
13 classifier
14 integration (global anomaly measure)
15 learning data database mainly including normal cases
21 anomaly measure
22 accuracy rate/false alarm rate
23 describability of anomaly preindication
24 time-series signal feature extraction/classification
25 preindication detection
26 anomaly diagnosis
31 observation data acquiring unit
32 learning data storing/updating unit
33 inter-data similarity calculating/computing unit
34 similarity determining unit
35 unit for determining deletion/addition from/to learning data
36 data deletion/addition instructing unit
41 learning data storing unit
42 inter-data similarity calculating/computing unit
43 similarity determining unit
44 unit for determining deletion/addition from/to learning data
45 data deletion instructing unit
51 observation data deviance calculating unit
52 unit for deciding normal range by histogram generation
53 learning data including normal cases
54 inter-data similarity calculating unit
60 similarity-based sensor signal
70 histogram of sensor signal levels
80 collateral information; event information
90 deviation from merged model of clusters in feature space
91 individual state in feature space
92 change of state in feature space
93 learning of a state in feature space and making a model of change
101 multidimensional signal acquiring unit
102 missing value correcting/deleting unit
103 state data/knowledge database
104 unit for deleting invalid signals according to correlation analysis
106 trajectory segmentation clustering
107 alarm signal/maintenance information
108 unit for modeling each cluster object
109 unit for calculating deviation from model
110 outlier detecting unit
111 unit for modeling feature selection of each cluster
112 histogram of accumulation of alarm signals or the like over a certain section
113 anomaly identifying unit
114 wavelet (transform) analyzing unit
115 unit for analyzing scatter diagram/correlation of trajectory of each cluster
116 unit for analyzing time/frequency for each cluster
117 learning data
118 modeling (1) unit
119 processor
120 display
121 database
122 physics model
123 relevant model allocating/deviation calculating unit
124 state change/overall deviation calculating unit
130 multidimensional time-series signal
131 correlation matrix
132 example of cluster
133 labeling in feature space
134 result of labeling on the basis of adjacent distance (speed) of all time series data
135 classification into class with short projection distance to r-dimensional subspace
136 case-based anomaly detection according to parametric complex statistical model
137 implementation of clustering by trajectory segmentation
138 multiple regression of result of labeling on the basis of adjacent distance (speed) of all time series data
139 local subspace classifier
140 local subspace classifier
141 visualization of data behavior (trajectory)
142 modeling of data per cluster
143 visualization of rate of data change
144 calculation of deviation from model
150 alarm signal histogram
151 add degree of anomaly or reliability to alarm signal
160 wavelet analysis
161 wavelet transform
170 scatter diagram analysis
171 cross-correlation analysis
180 time/frequency analysis

1. An anomaly detection method for early detection of an anomaly of a plant or a facility, wherein:
data is acquired from a plurality of sensors;
learning data is generated and/or updated on the basis of similarities among data by adding/deleting data to/from learning data and, in a case of data with low similarity among data, using an occurrence/nonoccurrence of an anomaly in the data with low similarity among data; and
an anomaly in observation data is detected on the basis of deviances between newly acquired observation data and individual pieces of data included in the learning data.

2. An anomaly detection method for early detection of an anomaly of a plant or a facility, wherein:
learning data is read out from a database; and
an amount of learning data is moderated by mutually obtaining similarities among learning data and deleting data so that data with high similarity is not duplicated.

3. An anomaly detection method for early detection of an anomaly of a plant or a facility, wherein:
with respect to learning data substantially including normal cases,
similarities among individual pieces of data included in the learning data are obtained and k pieces of data with highest similarities to each of the individual pieces of data are obtained; and
a histogram of data included in obtained learning data is obtained and a range of existence of normal cases is determined on the basis of the histogram.

4. An anomaly detection method for early detection of an anomaly of a plant or a facility, wherein:
with respect to learning data including substantially normal cases,
similarities among individual pieces of data included in the learning data and observation data are obtained and, for a plurality of pieces of observation data, k pieces of data with highest similarities to the observation data are obtained; and
a histogram of data included in the obtained learning data is obtained and, based on the histogram, at least one or more values such as a typical value, an upper limit, and a lower limit is set, and an anomaly is detected using the set values.

5. An anomaly detection method for early detection of an anomaly of a plant or a facility, wherein:
similarities among individual pieces of data included in learning data and observation data is obtained and, for a plurality of pieces of observation data, k pieces of data with highest similarities to the observation data are obtained; and
a histogram of data included in the obtained learning data is obtained and a deviance of the observation data is obtained on the basis of the histogram to identify which element of the observation data is an anomaly.

6. An anomaly detection method for early detection of an anomaly of a plant or a facility, wherein:
observation data is acquired from a plurality of sensors; and
alarm information generated by the facility and related to a facility shutdown or a warning is collected and a section including the alarm information generated by the facility and related to a facility shutdown or a warning is removed from learning data.

7. An anomaly detection method for early detection of an anomaly of a plant or a facility, wherein:
observation data is acquired from a plurality of sensors;
event information generated by the facility is acquired;
an analysis is performed on the event information; and
anomaly detection performed on a sensor signal and the analysis performed on the event information are combined to detect an anomaly.

8. An anomaly detection method for early detection of an anomaly of a plant or a facility, wherein:
observation data is acquired from a plurality of sensors;
a model of learning data is made by a subspace method; and
an anomaly is detected on the basis of a distance relationship between the observation data and a subspace.

9. The anomaly detection method according to claim 8, wherein
the subspace method is any of a projection distance method, a CLAFIC method, a local subspace classifier performed on a vicinity of the observation data, a linear regression method, and a linear prediction method.

10. The anomaly detection method according to claim 1, wherein:
observation data is acquired from a plurality of sensors;
a model of the learning data is made by a subspace method; and
an anomaly is detected on the basis of a distance relationship between the observation data and a subspace.

11. The anomaly detection method according to claim 10, wherein
a transition period in which data changes temporally is obtained, an attribute is added to transitional data, and the transitional data is collected or removed as learning data.

12. An anomaly detection method for early detection of an anomaly of a plant or a facility, wherein:
data is acquired from a plurality of sensors, a trajectory of a data space is segmented into a plurality of clusters on the basis of temporal changes in the data, a model of a cluster group to which a point of interest does not belong is made by a subspace method;
an outlier of the point of interest is calculated from a deviance from the model; and
an anomaly is detected on the basis of the outlier.

13. The anomaly detection method according to claim 7, wherein
alarm information generated by the facility and related to a facility shutdown or a warning is collected, and a section including the alarm information generated by the facility and related to a facility shutdown or a warning is removed from learning data.

14. An anomaly detection method for early detection of an anomaly of a plant or a facility, wherein:
observation data is acquired from a plurality of sensors;
a model of learning data is made by a subspace method;
an anomaly is detected on the basis of a distance relationship between the observation data and a subspace;
event information generated by the facility is acquired;
an analysis is performed on the event information; and
anomaly detection performed on a sensor signal and the analysis performed on the event information are combined to detect an anomaly.

15. An anomaly detection method for early detection of an anomaly of a plant or a facility, wherein:
observation data is acquired from a plurality of sensors;
a model of learning data is made by a subspace method;
an anomaly is detected on the basis of a distance relationship between the observation data and a subspace;
event information generated by the facility is acquired;
an analysis is performed on the event information;
anomaly detection performed on a sensor signal and the analysis performed on the event information are combined to detect an anomaly; and
an explanation of the anomaly is outputted.

16. An anomaly detection system for early detection of an anomaly of a plant or a facility, comprising:
a data acquiring unit that acquires data from a plurality of sensors; and
a similarity calculating unit that calculates a similarity among data, a data anomaly inputting unit that inputs an occurrence/nonoccurrence of an anomaly of data, a data addition/deletion instructing unit that instructs addition/deletion of data to/from learning data, and a learning data generating/updating unit, wherein
learning data is generated and/or updated on the basis of similarities among data by adding/deleting data to/from learning data and, in a case of data with low similarity among data, using an occurrence/nonoccurrence of an anomaly in the data with low similarity among data; and
an anomaly in observation data is detected on the basis of deviances between newly acquired observation data and individual pieces of data included in the learning data.

17. An anomaly detection system for early detection of an anomaly of a plant or a facility, comprising:
a similarity calculating unit that calculates a similarity among data, and a data deletion instructing unit that instructs deletion of data from learning data, wherein
an amount of learning data is moderated by mutually obtaining similarities among data and deleting data so that data with high similarity is not duplicated.

18. An anomaly detection system for early detection of an anomaly of a plant or a facility, comprising:
a learning data unit including substantially normal cases, a similarity calculating unit that calculates a similarity among data, and an observation data histogram calculating unit, wherein
with respect to learning data including normal cases, similarities among individual pieces of data included in the learning data are obtained and k pieces of data with highest similarities to each of the individual pieces of data are obtained, and
a histogram of data included in obtained learning data is obtained and a range of existence of normal cases is determined on the basis of the histogram.

19. An anomaly detection system for early detection of an anomaly of a plant or a facility, comprising:
a learning data unit including substantially normal cases, a similarity calculating unit that calculates a similarity among data, an observation data histogram calculating unit, and a setting unit that sets at least one or more values such as a typical value, an upper limit, and a lower limit, wherein
with respect to learning data including normal cases,
similarities among individual pieces of data included in the learning data and observation data are obtained, k pieces of data with highest similarities to the observation data are obtained for a plurality of pieces of observation data,
a histogram of data included in obtained learning data is obtained, at least one or more values such as a typical value, an upper limit, and a lower limit are set on the basis of the histogram, and an anomaly is detected using the set values.

20. An anomaly detection system for early detection of an anomaly of a plant or a facility, comprising:
a learning data unit including substantially normal cases, a similarity calculating unit that calculates a similarity among data, and an observation data histogram calculating unit, wherein
similarities among individual pieces of data included in the learning data and observation data are obtained, k pieces of data with highest similarities to the observation data are obtained for a plurality of pieces of observation data,
a histogram of data included in obtained learning data is obtained, and a deviance of the observation data is obtained on the basis of the histogram to identify which element of the observation data is an anomaly.

21. An anomaly detection system for early detection of an anomaly of a plant or a facility, comprising:
a data acquiring unit that acquires data from a plurality of sensors; and
a similarity calculating unit that calculates a similarity among data, a data anomaly inputting unit that inputs an occurrence/nonoccurrence of an anomaly of data, a data addition/deletion instructing unit that instructs addition/deletion of data to/from learning data, and a learning data generating/updating unit, wherein
alarm information generated by the facility and related to a facility shutdown or a warning is collected, and a section including the alarm information generated by the facility and related to a facility shutdown or a warning is removed from learning data.

22. An anomaly detection system for early detection of an anomaly of a plant or a facility, comprising:
a data acquiring unit that acquires data from a plurality of sensors; and
a similarity calculating unit that calculates a similarity among data, a data anomaly inputting unit that inputs an occurrence/nonoccurrence of an anomaly of data, a data addition/deletion instructing unit that instructs addition/deletion of data to/from learning data, and a learning data generating/updating unit, wherein
event information generated by the facility is acquired,
an analysis is performed on the event information, and
anomaly detection performed on a sensor signal and the analysis performed on the event information are combined to detect an anomaly.

23. An anomaly detection system for early detection of an anomaly of a plant or a facility, comprising:
a data acquiring unit that acquires observation data from a plurality of sensors; a subspace method modeling unit that makes a model of learning data by a subspace method; and a distance relationship calculating unit that calculates a distance relationship between observation data and a subspace, wherein
observation data is acquired from a plurality of sensors, a model of learning data is made by a subspace method, and
an anomaly is detected on the basis of a distance relationship between the observation data and a subspace.

24. The anomaly detection system according to claim 23, wherein
the subspace method is any of a projection distance method, a CLAFIC method, a local subspace classifier performed on a vicinity of the observation data, a linear regression method, and a linear prediction method.

25. The anomaly detection system according to claim 16, comprising:
a data acquiring unit that acquires observation data from a plurality of sensors; a subspace method modeling unit that makes a model of the learning data by a subspace method; and a distance relationship calculating unit that calculates a distance relationship between observation data and a subspace, wherein
observation data is acquired from a plurality of sensors, a model of learning data is made by a subspace method, and
an anomaly is detected on the basis of a distance relationship between the observation data and a subspace.

26. The anomaly detection system according to claim 25, wherein
a transition period in which data changes temporally is obtained, an attribute is added to transitional data, and the transitional data is collected or removed as learning data.

27. An anomaly detection system for early detection of an anomaly of a plant or a facility, comprising:
a data acquiring unit that acquires observation data from a plurality of sensors; a clustering unit that segments a trajectory of a data space into a plurality of clusters; a subspace method modeling unit that makes a model of data by a subspace method; and a deviance calculating unit that calculates an outlier of a point of interest from the model on the basis of a deviance, wherein
data is acquired from a plurality of sensors, a trajectory of a data space is segmented into a plurality of clusters on the basis of temporal changes in the data, a cluster group to which a point of interest does not belong is modeled by a subspace method,
an outlier of the point of interest is calculated from a deviance from the model, and
an anomaly is detected on the basis of the outlier.

28. The anomaly detection system according to claim 22, comprising:
an alarm information collecting unit that collects alarm information generated by the facility and related to a facility shutdown or a warning, wherein a section including the alarm information generated by the facility and related to a facility shutdown or a warning is removed from learning data.

29. An anomaly detection system for early detection of an anomaly of a plant or a facility, comprising:
a data acquiring unit that acquires observation data from a plurality of sensors; a subspace method modeling unit that makes a model of learning data by a subspace method; a distance relationship calculating unit that calculates a distance relationship between observation data and a subspace; an anomaly detecting unit; and an event information analyzing unit that performs analysis on event information, wherein
observation data is acquired from a plurality of sensors,
a model of learning data is made by a subspace method,
an anomaly is detected on the basis of a distance relationship between the observation data and a subspace;
event information generated by the facility is acquired,
an analysis is performed on the event information, and
anomaly detection performed on a sensor signal and the analysis performed on the event information are combined to detect an anomaly.

30. An anomaly detection system for early detection of an anomaly of a plant or a facility, comprising:
a data acquiring unit that acquires observation data from a plurality of sensors; a subspace method modeling unit that makes a model of learning data by a subspace method; a distance relationship calculating unit that calculates a distance relationship between observation data and a subspace; an anomaly detecting unit; an event information analyzing unit that performs analysis on event information; and an anomaly explaining unit that explains an anomaly, wherein
observation data is acquired from a plurality of sensors,
a model of learning data is made by a subspace method,
an anomaly is detected on the basis of a distance relationship between the observation data and a subspace;
event information generated by the facility is acquired,
an analysis is performed on the event information,
an anomaly detection performed on a sensor signal and the analysis performed on the event information are combined to detect an anomaly, and
an explanation of the anomaly is outputted.
